(19) United States
(12) Patent Application Publication
(10) Pub. No.: US 2013/0046673 A1
(43) Pub. Date: Feb. 21, 2013

(54) Securitization System and Process II

(71) Applicant: Kenneth Kiron, Teaneck, NJ (US)

(72) Inventor: Kenneth Kiron, Teaneck, NJ (US)

(73) Assignee: Edgeshares LLC, New York, NY (US)

(21) Appl. No.: 13/586,731

(22) Filed: Aug. 15, 2012

Related U.S. Application Data
(60) Provisional application No. 61/523,736, filed on Aug. 15, 2011.
(60) Provisional application No. 61/531,838, filed on Sep. 7, 2011.
(60) Provisional application No. 61/531,853, filed on Sep. 7, 2011.
(60) Provisional application No. 61/536,234, filed on Sep. 19, 2011.

(51) Int. Cl. G06Q 40/04

(52) U.S. Cl. 705/37

(57) ABSTRACT

An investable product is designed, created and managed comprising a number of shares outstanding subject to a mandatory stock split or reverse stock split at the close of every trading period. An account comprising the investor share balance is configured to display on a daily basis the original share balance owned through the calculation of a factor. The product comprises an adjustable stop loss feature that provides investors with the opportunity to automatically reinvest their capital if they are stopped out. When the shares are held for one day or longer, a leveraged return is obtainable with no price path dependency or leverage drift.

### CROSS-REFERENCE TO RELATED APPLICATIONS

This application claims priority to U.S. Provisional Patent Application Ser. Nos. 61/523,736 filed Aug. 15, 2011, 61/531,838 filed Sep. 7, 2011, 61/531,853 filed Sep. 7, 2011, and 61/536,234 filed Sep. 19, 2011. This application also incorporates by reference U.S. Utility patent application Ser. No. 13/019,936 filed Feb. 2, 2011, and U.S. Pat. No. 7,698,192 to Kiron, issued on Apr. 13, 2010.

### TECHNICAL FIELD OF THE INVENTION

The present invention relates to reducing the tracking error of a leveraged investable product, including but not limited to an Exchange Traded Fund (ETF), Exchange Traded Note (ETN), Exchange Traded Commodity Pool (ETC), Trust and or Mutual Fund, all of which can be traded on an exchange or off the exchange.

### BACKGROUND OF THE INVENTION

Both Leveraged and Inverse Exchange Traded Products (including, but not limited to those structured as Exchange Traded Funds and Notes) are complex financial instruments that are typically designed to achieve their stated investment performance objectives on either a daily, monthly or lifetime basis. Due to the effects of compounding, their performance over longer periods of time can differ significantly from their stated daily objective. Because of this, FINRA (the Financial Industry Regulatory Authority), stated in a Jun. 2, 2009 regulatory notice that “inverse and leveraged ETFs that are reset daily typically are unsuitable for retail investors who plan to hold them for longer than one trading session, particularly in volatile markets.” The impact of this notice on the industry has been swift and dramatic. At least one brokerage firm has banned these products outright and others have imposed limitations on how and when their retail clients can trade them.

As FINRA states, “ETFs are typically registered unit investment trusts (UITs) or open-end investment companies whose shares represent an interest in a portfolio of securities that track an underlying benchmark or index.” However, some ETFs that invest in commodities, currencies, or commodity- or currency-based instruments are not registered as investment companies. Leveraged ETFs seek to deliver multiples of the performance of the index or benchmark they track. Some leveraged ETFs are “inverse” or “short” funds, meaning that they seek to deliver the opposite of the performance of the index or benchmark they track. Like traditional ETFs, some inverse ETFs track broad indices, some are sector-specific, and still others are linked to commodities or currencies. Inverse ETFs are often marketed as a way for investors to profit from, or at least hedge their exposure to, downward moving markets. Some funds are both short and leveraged, meaning that they seek to achieve a return that is a multiple of the inverse performance of the underlying index. An inverse ETF that tracks the S&P 500, for example, seeks to deliver the inverse of the performance of the S&P 500, while a 2× leveraged inverse S&P 500 ETF seeks to deliver twice the opposite of that index's performance. To accomplish their objectives, leveraged and inverse ETFs pursue a range of investment strategies through the use of swaps, futures contracts and other derivative instruments. Most leveraged and inverse ETFs “reset” daily, meaning that they are designed to achieve their stated objectives on a daily basis. Due to the effect of compounding, their performance over longer periods of time can differ significantly from the performance (or inverse of the performance) of their underlying index or benchmark during the same period of time.

For example, between Dec. 1, 2008, and Apr. 30, 2009, the Dow Jones U.S. Oil & Gas Index gained 2 percent, while an ETF seeking to deliver twice the index's daily return fell 6 percent and the related ETF seeking to deliver twice the inverse of the index's daily return fell 26 percent. An ETF seeking to deliver three times the daily return of the Russell 1000 Financial Services Index fell 53 percent while the index actually gained around 8 percent. The related ETF seeking to deliver three times the inverse of the index's daily return declined by 90 percent over the same period. This effect can be magnified in volatile markets. Using a two-day example, if the index goes from 100 to close at 101 on the first day and back down to close at 100 on the next day, the two-day return of an inverse ETF will be different than if the index had moved up to close at 110 the first day but then back down to close at 100 on the next day. In the first case with low volatility, the inverse ETF loses 0.02 percent; but in the more volatile scenario the inverse ETF loses 1.82 percent. The effects of mathematical compounding can grow significantly over time, leading to scenarios such as those noted above.

As a result of the substantial tracking error which occurs over more than one day (due to daily mathematical compounding), there has been a significant industry backlash against daily resetting leveraged ETFs. For instance, on Jul. 27, 2009, UBS stated that it would not trade ETFs that use leverage. Ameriprise Financial and LPL Investment Holdings Inc. have also prohibited sales of leveraged ETFs that seek more than twice the long or short performance of their target index.

In an effort to mitigate the daily compounding effect associated with daily resetting leveraged and inverse leveraged ETFs, Fund Sponsors have recently introduced monthly resetting leveraged and inverse leveraged ETFs, which seek to deliver leveraged results over the course of a month. For example, if the index underlying a monthly 2× fund gained 10% in January, the leveraged products would be expected to gain 20% over the same time period. These returns would be generated regardless of the path taken by the underlying index during the month—but only if an investor bought the product on the IPO date and sold on the month end date. If the investor held the product through February however, he would not be expected to receive the total return of the index from January through the end of February. Rather, he would receive the compounded return of the January return and February return—not the sum of the two. The investor would have to sell part of his profits at the end of each month to avoid a compounding effect, or buy more if it went down, to avoid a decompounding effect. This performance return profile exists because the ETP is rebalanced monthly, (causing a compounding effect to occur) which prevents investors from matching the quarterly or yearly performance of the index. In addition, because the exposure is reset only once per month, the effective daily leverage of the product will deviate from the target multiple between resets for subsequent investors.

In addition to daily and monthly resetting leveraged products, there is currently a third category of leveraged products offering “lifetime” fixed leverage—fixed leverage for the life of the product. The product, offered by Barclays, is structured as an ETN and provides a mechanism for fixed leveraged exposure to an underlying index without the price path-dependency and compounding concerns of daily-reset or monthly-reset leveraged ETFs—but like the monthly-reset products, only if you buy on the IPO date. After the IPO date, subsequent investors will be subject to daily leverage “drift” as the leverage will change in response to the underlying Index. After the IPO date, unless the index remains unchanged, new investors will not receive the original leverage offered. The leverage may in fact be substantially less or more than the leverage initially offered.

However, in summary, daily resetting leveraged ETPs suffer from price path dependency and tracking errors for investors who buy and hold them for more than a day. Monthly resetting ETPs generate tracking errors when held for more than one month due to monthly rebalancing and suffer from leverage drift when purchased intra-month. Lifetime leverage products suffer from leverage drift when purchased at any time after the IPO date (unless the index is unchanged from the IPO date).

Currently, all of the existing daily, monthly and lifetime leveraged and inverse ETPs and linked products presently available (collectively representing over $40 Billion in assets under management) suffer a number of disadvantages for investors who wish to receive fixed point to point leverage, including:

A) Daily Leveraged and Inverse ETPs suffer from tracking errors caused by price path dependency.

B) Daily Leveraged and Inverse ETPs require investors to perform multiple steps on a daily basis to overcome price path dependency, including: At the end of each trading day, investors must determine what their gains and losses are; then if they have a gain, investors are forced to sell a portion of their portfolio so that their gains are not compounded. The disadvantage is a daily tax impact. As the investment is not held more than one year, it is subject to high short term capital gains treatment. In addition, commission expenses are incurred which increase trading costs. If they have a loss at the end of the day, investors must invest more capital to maintain fixed leverage. The disadvantage here is that investors may not have more capital to invest. In addition, they have to incur additional commission expenses which increase trading costs. Investors may not have the time or expertise to develop algorithms to automate this end of day process or to manually perform the needed calculations to avoid price path dependency. In addition, the bid/ask spreads required to continually enter and exit the positions at the end of each day will cause further tracking error over time.

C) Daily Leveraged and Inverse ETP investors can lose a substantial portion of their capital, even if they guess right about the direction of the market.

D) Daily Leveraged and Inverse ETP Investors cannot use the products as a unmanaged fixed hedge against their investments without the risk of substantial tracking error.

E) Investors cannot anticipate the correlation of daily leveraged ETP return against an underlying benchmark or index over time.

F) Monthly Leveraged and Inverse ETPs suffer from Leverage drift after the IPO date and tracking error if held for more than one month.

G) Lifetime Leverage and Inverse ETPs suffer from leverage drift after the IPO date.

H) Lifetime Leverage and Inverse ETPs cannot determine for their future investors in advance what their leverage exposure will be for an underlying benchmark or index on any given day.

I) Multiple brokerage firms will not allow their retail clients to trade Leveraged ETPs because of the price path dependency issue.

J) Due to the price path dependency problem, the Securities & Exchange Commission issued a directive in 2010 freezing the approval of new exemptive relief applications for new Leveraged Exchange Traded Funds, preventing new ETF products from being approved until further notice.

### SUMMARY OF THE INVENTION

U.S. Patent Publication No. US2011/0191234 (i.e., Ser. No. 13/019,936) entitled “Securitization System and Process” discloses in an embodiment a Leveraged Exchange Traded Product that provides investors with point to point constant leverage over a time period of one day or longer with no leverage drift, no price path dependency along with a mandatory redemption feature that provides the investor with two or more securities on the day after owning Fund XX.

In an embodiment the instant invention provides a more compelling user experience by modifying an investable product (e.g. Fund XX) in various ways so as to not require either a mandatory redemption feature or the need to own two securities. One amongst many of the enabling means to accomplish this relates to adjusting the number of shares owned by each shareholder on a daily basis. In particular, the fractional ownership interest that an investor has in the product, as represented by the number of shares owned (or in the case of an ETN, Units), will change over time even in the absence of a buy or sell transaction. In order to mitigate confusion as to the number of shares owned, the number of shares owned will be displayed daily as the original amount purchased. This process is made possible by the periodic calculation and display of a Shareholder Adjustment Factor (SAF), which is used to determine the market value and settlement value of shares owned and sold. As brokerage firms don't currently support the display of such a factor, one product embodiment is to create a non-exchange traded mutual fund incorporating the SFA within a direct shareholder account with the mutual fund. An investor or Registered Investment Adviser (RIA) can log into the mutual fund sponsor website and buy or sell transactions directly from the mutual fund company at the close of each trading period. Alternatively, the investor can phone, email or purchase through a fund supermarket shares of the fund. Other variations are possible, including having the product traded on an exchange. It must be noted that the SAF is an optional feature and can be included or excluded as a feature within the exchange traded or non exchange traded product.

The valuation of the product portfolio can be done on a periodic basis (for example real-time, hourly or daily) and then divided by either the current or closing price of the fund (for example, real-time hourly or daily) to achieve an exemplary calculation of the SAF. The amount of shares owned by investors can be reported as a constant number over time, such as a daily basis, noting however that if the investor buys or sells shares or the Fund performs a stock split or the like, the share balance can be changed by the Clearing Agent and/or the Transfer Agent of the Fund. The closing period market value of the investor position on any given day can be reported as the closing number of shares held multiplied by the closing price of the ETF multiplied by the SAF. When an investor sells shares of the fund, the settlement proceeds can be calculated using a computer (in one embodiment) as the sold number of shares multiplied by the executed sale transaction price multiplied by the closing SAF (commissions and other brokerage fees and expenses can likely apply as well).

A calculation and publication of an intraday estimation of a factor value can enable participants to see a theoretical market value (also referred to as position value) of shares owned. Unlike existing ETFs that provide an indicative estimated value of the funds holdings, shareholders of one embodiment can be able to see a unique and different piece of information—the determination of the estimated fund holdings value DIVIDED by the current price. Either the Fund Administrator, Agent or third party can calculate and disseminate this data in real-time or delayed.

In an embodiment, the benefits of a single ticker product (whether exchange traded or not) include, but are not limited to:
1. In an exchange traded version, the ability to have a reduced commission expense as an investor would need to sell only one security instead of two over time.
2. In an exchange traded version, the ability to have a reduced trading friction expense as an investor would not be subject to the bid/ask spread of two or more securities over time.
3. A simpler reporting of the daily Profit & Loss as it will apply to just one product.
4. A simpler hedge.
5. Fewer positions to maintain over time.
6. The ability to write either an exchange listed or unlisted covered call option on a single position.
7. The ability to sell short one product instead of two.
8. An automatic stop loss provision with the ability to automatically reinvest capital back into the product.
9. The proprietary nature of the inventive system can offer an exchange the opportunity to list the product on an exclusive basis, providing a higher market share than would otherwise be possible under Regulation NMS.

As discussed above, the present invention also relates to providing an investor with the automated ability to maintain a position within an investable product, including but not limited to a non price path dependent leveraged Exchange Traded Fund (ETF), Trust or Mutual Fund, even after a stop loss trigger event.

Currently, to protect an investment from going down significantly in value, an investor can employ a trade called a stop loss. This is based upon the personal risk tolerance of an individual. In a typical stop loss event, an investor places an order to sell his securities if a certain threshold price level is reached. This prevents an investor from losing more money if the price goes down further. Once the level is reached, the investor's brokerage firm will automatically liquidate his or her securities and place a cash amount of money with the proceeds back in his or her account (if any). At that point, the investor can hold the cash or make another investment, even back into the same security. This can occur manually by placing the order through a broker or via electronic trading. It would be helpful for an investor who owns a pooled financial product (and where the product portfolio may be impacted by multiple stop loss events, depending upon when and at what price the investor purchased the product) to automatically reinvest the proceeds of a stop loss event back into the product.

In an embodiment the presently disclosed inventive system and method of reducing tracking error in leveraged ETPs allows investors to receive an investment return that provides: (a) fixed point to point leverage over any time period with no compounded return on investment for any benchmark, index or non benchmark or non index; (b) fixed point to point leverage over any time period with no leverage drift for any benchmark of index; (c) a constant daily fixed leverage to a benchmark or index or non benchmark or non index without the need to actively manage a portfolio's daily exposure once the position is established; (d) a ‘set and forget’ passively managed leveraged product that incurs relatively little trading costs compared to existing products to maintain the opening position leverage; (e) a single ticker product with no daily mandatory redemption feature; and, (e) an effective hedge.

In an embodiment, the present invention improves upon the existing methodologies employed by leverage and inverse Exchange Traded Funds (ETF), Mutual Funds and Exchange Traded Notes (ETN) sponsors and issuers to correlate returns to a benchmark or index by producing a non-price path dependent financial product that has no tracking error and which provides a statistically significant and greater degree of accuracy in tracking a benchmark or index over a period of one day or longer. Specifically, in an embodiment in accordance with the present invention, an exchange traded product, the preferred embodiment being an ETF, is created whereby it has a preferred portfolio of securities that provide an investment return that meets a target leverage level. The preferred portfolio provides an investor with a combined weighted average leverage of a determined amount which will be fixed for as long as Investors hold the Fund. The product adjusts the number of shares outstanding at the close of each trading period through a corporate action. The corporate action can comprise of a stock split or a reverse stock split and can be based, at least in part, on the closing value of the assets invested by the product.

In still yet another embodiment, a computer-implemented system is provided for exchanging shares in an exchange traded product. The system includes a display for displaying data representing shares of an exchange traded product comprising a leveraged portfolio of securities satisfying market capitalization criteria, the securities within the portfolio being weighted and having an expected return that is both greater than, and less than, the desired expected return of the exchange traded product, wherein the leveraged exchange traded product is configured for trading shares of the leveraged exchange traded product at a mutually agreed upon price of the shares related to the underlying price of each of the selected securities comprising the leveraged exchange traded product and related to the respective weightings of the selected securities. The system also includes an exchange computer for processing the exchange of the shares at a price related to the price of the securities within the leveraged portfolio. In another embodiment, a system is provided for creating an exchange traded product having a portfolio management, trading and/or accounting computer system incorporating a processor for calculating at least an end of day weighting ratio derived from the securities based upon user defined criteria (for example, risk, leverage, liquidity, capitalization, volatility) contained in the database or other electronically accessible storage/display medim, the processor weighting the selected securities within the exchange traded product based on a set of defined weighting ratio criteria. Moreover, the exchange traded product is configured for trading of shares of the exchange traded product at a mutually agreed upon price of the shares related to an underlying price of each, or in combination all of the selected securities comprising the exchange traded product and related to the weightings of the selected securities.

In a further embodiment, a computer-implemented system is provided for exchanging shares in a leveraged exchange traded product. The system includes a display (either electronic, visual) for displaying data representing shares of an exchange traded product comprising a leveraged portfolio of securities satisfying market capitalization and leverage criteria, one or more of the securities within the portfolio being weighted and having an expected return that is both greater than, and or less than, the desired expected return of the exchange traded product, wherein the leveraged exchange traded product is configured for trading shares of the leveraged exchange traded product at a determined price of the shares related to the underlying price of each of the selected securities comprising the leveraged exchange traded product and related to the respective weightings of the selected securities. The system also includes an exchange computer for processing the exchange of the shares at a price related to the price of the securities within the leveraged portfolio.

In a further embodiment, a computer-implemented method for trading securities in an electronic market is provided, the method comprising receiving by a server system an order that specifies a quantity of a security, entered at a client station, for executing against any market participant that can satisfy a portion of the order; and matching the entered order by the server system against a trading interest in the market, with the trading interest comprising quotes and orders of market makers or other market participants.
In a further embodiment, a Fund of Funds can purchase the preferred portfolio by using ETFs, ETNs or other products. For example, a new fund of funds product can be created that invests in the SP500 through two other funds, one being a 1 times fund, the other being a 3 times total return ETN.

In addition, current indices created and maintained by Index Calculation firms are generally not leveraged indices representing a multiple of an index. By creating such an Index, leverage ETFs may have a more relevant benchmark to gauge their performance and associated tracking errors by. A method of creating and maintaining such Index representing a value derived from the calculation of at least two times the total return of its constituents over time is shown below, said method comprising the steps of:
a) Choosing constituents of the Index.
b) Determining using a computer a closing daily value of the constituents.
c) Using a computer processor to multiply step b) by at least 2.
d) Divide step c) by a user defined weighting methodology.
e) Publishing an intraday and/or closing value of the Index.
f) Repeating steps a) through e) on an intraday, daily, weekly, monthly or yearly basis.

An ETF can then track the index. A derivative security can then be bought or sold based upon the value of the leveraged ETF or the Index.

In addition, to enhance liquidity and fungibility as well as to facilitate arbitrage, in a further embodiment the ETF sponsor has the ability to accept a pre-defined percentage (from 0 to 100%) of underlying nominal of a group of one or more securities comprising the benchmark or index as part of the sponsor creation/redemption process and to provide the ability to create and redeem not only daily but also in real-time or intra-day. Other structures can also be considered besides an ETF, including a debt instrument (such as an ETN), a trust (grantor, business or unit), a commodity pool that is exchange traded, or other defined product structure. Linked Derivatives (including but not limited to single share futures, index futures, commodity futures, structured products, options, swaps, warrants) can then be listed and traded on the product. In addition, off exchange products can be created in the form of mutual funds (either closed end or open end).

Furthermore, some exchanges offer various levels of service including Level I, II, III through workstations that provide quotations, executions, trade reporting, and trade negotiations and clearing. Level II provides current bid and offer quotes by all market makers for firms trading for themselves and for customers. Level III, designed for market makers, provides Level II services plus the ability for quoter/market participants and other users to enter quotations, direct/execute orders and send information. Since the late 1970s, all SEC-registered exchanges and market centers that trade NYSE or AMEX-listed securities send their trades and quotes to a central consolidator where the Consolidated Tape System (CTS) and Consolidated Quotation System (CQS) data streams are produced and distributed worldwide. In an embodiment the inventive system allows such workstations and consolidated tape/quotation systems to provide bid and offer quotes and direct/execute orders on the inventive products and to have such bids/offers and executions disseminated on one or more tape systems. In addition, the product may be listed on a primary exchange or listed through Unlisted Trading Permissions (UTP).

These and other features of the invention will be more readily apparent upon reading the following description of the preferred and other embodiments of the invention and upon reference to the accompanying drawings.

### BRIEF DESCRIPTION OF THE DRAWINGS

The present invention will be more fully understood by reference to the following detailed description thereof when read in conjunction with the attached drawings and wherein:

FIG. 1 (EXHIBIT 1) depicts the position of an investor who owns a single ticker product over time that is subject to a daily stock split.

FIG. 2 (EXHIBIT 2) depicts step by step how a Shareholder Adjustment Factor (SAF) is calculated.

FIG. 3 (EXHIBIT 3) depicts how a calculated SAF value is applied to determine a market value for an investor position.

FIG. 4 (EXHIBIT 4) depicts how a calculated factor value is applied to determine a market value for investor positions.

FIG. 5 (EXHIBIT 5) depicts a comparison between the change in market value and closing (e.g. settled) price amongst a traditional leveraged ETF and the preferred embodiment.

FIG. 6 (EXHIBIT 6) depicts a system and method of creating a leveraged product comprising a leveraged portfolio of one or more securities that satisfies a leveraged return target for an investor who owns the product.

FIG. 7 (EXHIBIT 7) depicts both the daily and inception to date profit and loss statement for the preferred embodiment.

FIGS. 8, 8A, 8B, 8C, 8D shows how a Fund sponsor can create and manage XX in conjunction with a clearing, custodian and portfolio management system.

FIG. 9 depicts how a Fund sponsor can create and manage XX in conjunction with a real-time or intra-day creation/redemption by acting as a direct dealer or market maker. Other variations are possible, such as allowing institutions to trade the product at or close to NAV amongst themselves through an electronic trading platform (whether located on an exchange or off the exchange).

FIG. 10 depicts the weighting change of securities as the index moves up over time and the impact on a built in stop loss level.

FIG. 11 depicts the segregation and allocation of a swaps portfolio to targeted investors.

FIG. 12 depicts a system of Reinvestment of Capital Through A Stop loss Event for Targeted Investors.

FIG. 13 depicts a summary of how a portfolio manager invests in a portfolio swaps within a product that adjusts the number of shares outstanding daily.

FIG. 13A provides an example of how a portfolio manager invests in a portfolio swaps within a product that adjusts the number of shares outstanding daily.

FIGS. 14, 14A, 14B, 14C, 14D, 14E depicts the different settlement cycles associated with a traditional Mutual Fund, an ETN and an ETF or Trust and how a clearing firm can clear each product.

FIG. 15 depicts a comparison of the Preferred Embodiment to existing products.

FIG. 16 depicts a multi-party global communications and information management technology platform designed, created and maintained to support the determination and dissemination daily stock splits and other relevant data associated when an ETF (or group) is listed individually or dually listed around the world in one or multi-time zones comprising at least the fund companies, the clearing entities, the transfer agencies, the brokerage firms and investors.

FIG. 17 depicts broad types of mutual funds.

### DETAILED DESCRIPTION OF THE INVENTION

The following descriptions of detailed embodiments are for exemplifying the principles and advantages of the inventions. They are not to be taken in any way as limitations on the scope of the inventions.

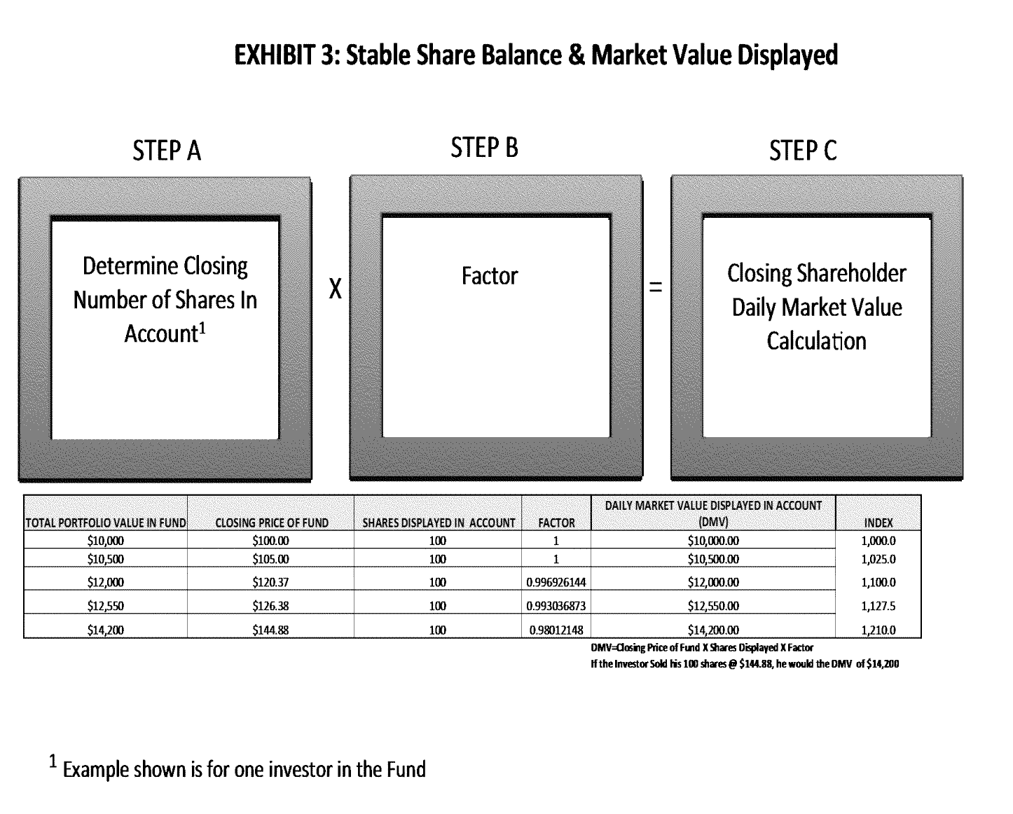

One embodiment in accordance with the present inventive system is an exchange traded fund (ETF) that is designed, created and managed to provide investors with point to point constant leverage over a time period of one day or longer with no leverage drift, no price path dependency and a non daily mandatory redemption feature. The number of shares outstanding is subject to a mandatory stock split or reverse stock split at the close of every trading period. The share balance of the investor position is displayed as the original amount owned (or sold short) within an investor account in the absence of a buy or sell transaction while the daily market valuation of the investor position is calculated in conjunction with a daily adjustment factor. The adjustment factor is determined by calculating the portfolio value of the Product and dividing it by the Net Asset Value price on a daily (or periodic) basis. The closing Net Asset Value Price (or equivalent) will correlate closely with the closing traded price of the product. The daily closing (or settlement) price of the ETF will closely reflect the daily return of an index, benchmark or non index or non benchmark, multiplied by a user defined target or number (such as a multiple or inverse multiple). The closing price of the product over time will be compounded each day while the portfolio value of the product will not. The fund incorporates an adjustable stop loss feature that adjusts over time as the product meets user-defined criteria such as rising above certain valuation levels. Investors are given the opportunity to automatically reinvest their capital if they are stopped out of the product. A list of features associated with one embodiment include:
Single ticker to buy or sell on a daily basis.
Daily stock split or reverse split on all outstanding shares.
No daily mandatory redemption feature, which means that investors will not need to directly own two or more different securities, or have their capital exchanged on a daily basis into two or more different securities after they buy “XX”. Instead, they will own XX continuously.
In conjunction with a shareholder adjustment factor, the number of shares displayed in an investor account can be fixed until a buy or sell transaction occurs. Exceptions can occur due to a corporate action, including but not limited to a distribution, dividend, etc.
Settlement proceeds of shares sold by investors can be adjusted by a Factor according to the formula: Sold Quantity×Executed Price×the most current (and relevant) factor. In one embodiment, this can be the closing day factor. Other formula constructions can be used that provide the same result, including intra-day factors.
Daily market value of investor positions can be a function of the shares held, the settlement price of the Fund and a closing Factor published by the Fund Administrator or agent.
Investors can opt-in or opt-out of an automatic reinvestment of capital in the event of a stop loss. In a different embodiment, the automatic reinvestment of capital can be mandatory.
The Net Asset Value (N.A.V) price of the product would track a compounded price return.
The closing price or last traded price, while not necessarily reflecting the return of the products investments over time, would reflect a compounded price return.
Portfolio value of investor holdings will not be based upon a compounded return. It can be based upon investments correlating to a weighting solution that provides for a substantially fixed point to point leverage return for both existing capital and new capital that comes into the fund on a periodic basis. An example of one possible exception (amongst many) can be in the event of a stop loss where residual investor capital is automatically reinvested.
Investors will not be subject to leverage drift.
Portfolio can contain leverage-able securities to provide a leverage solution for new and existing capital in the ETF. Examples amongst many of such securities can include derivatives such as futures, swaps, options, leveraged and non leveraged funds.
The stop loss can be adjustable. In a different embodiment, it can only be adjusted upwards or downwards.
The closing value of the portfolio of the product can be divided by the closing N.A.V. of the fund to determine the value of a closing Factor as described in more detail in FIG. 2. This factor can be published after it was calculated. Those skilled in the art would know that it could be divided by a 100 or some other number to decimalize it or any other user preferred numerical result. The factor can be applied to any shareholder who wishes to sell shares to determine the correct settlement proceeds of their transaction(s) and/or market value of their position and allow the amount of shares they own to be displayed as a fixed number over time (in the absence of a buy or sell transaction).

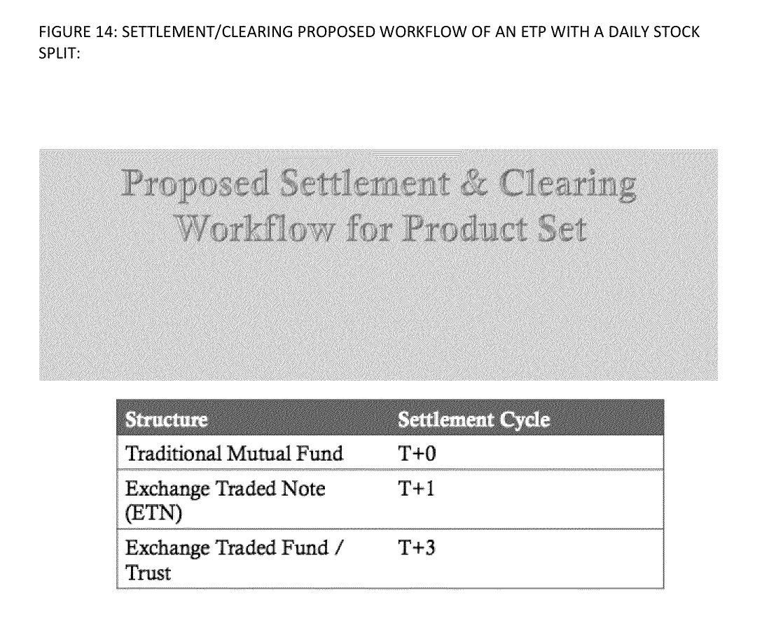

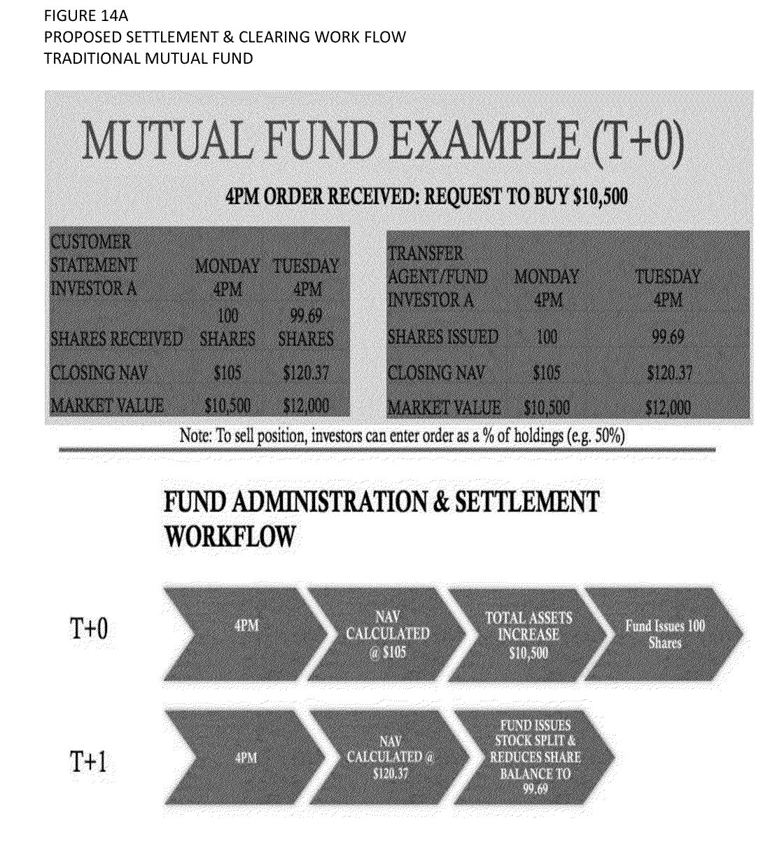

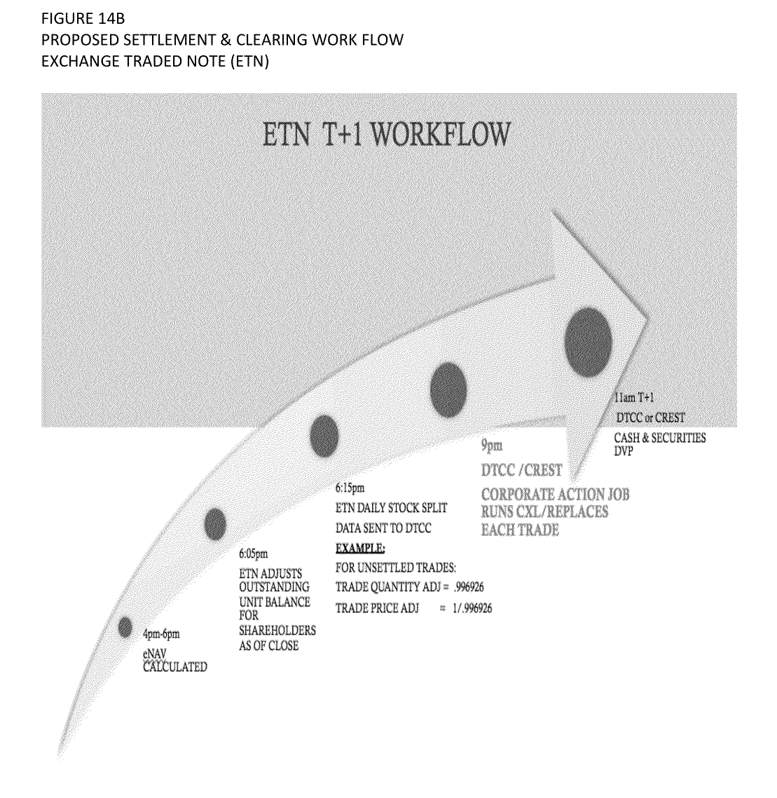

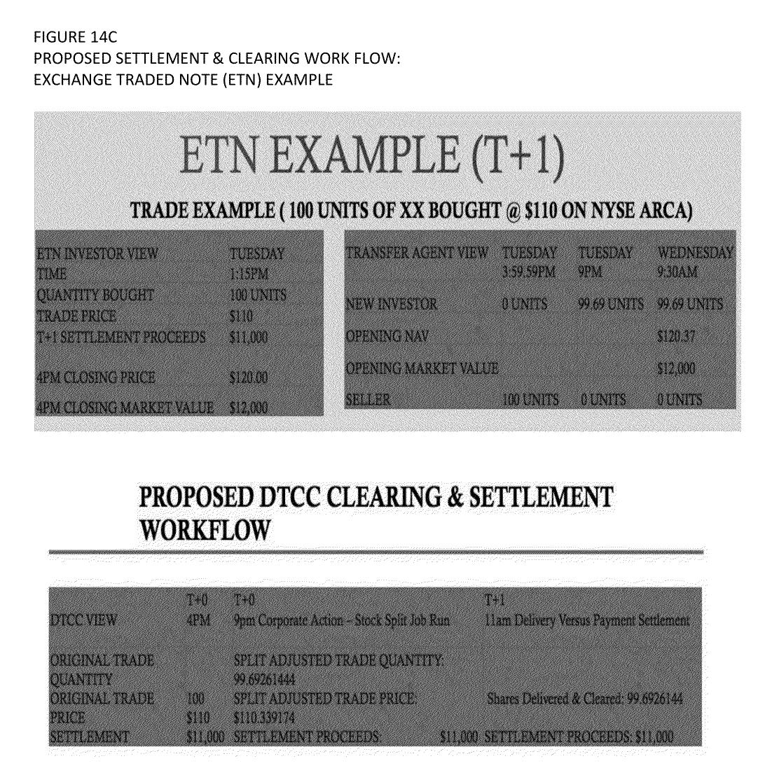

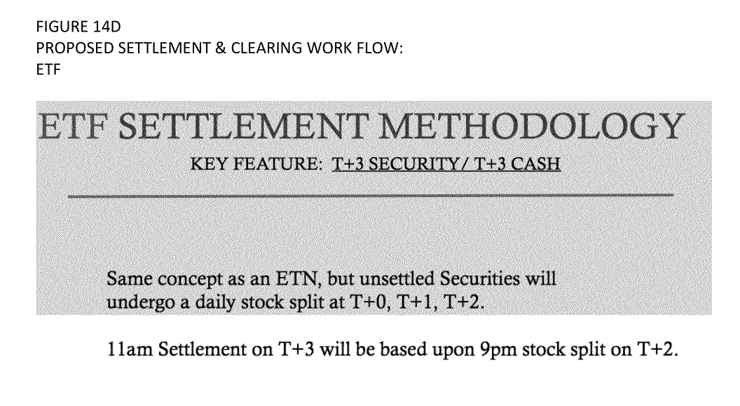

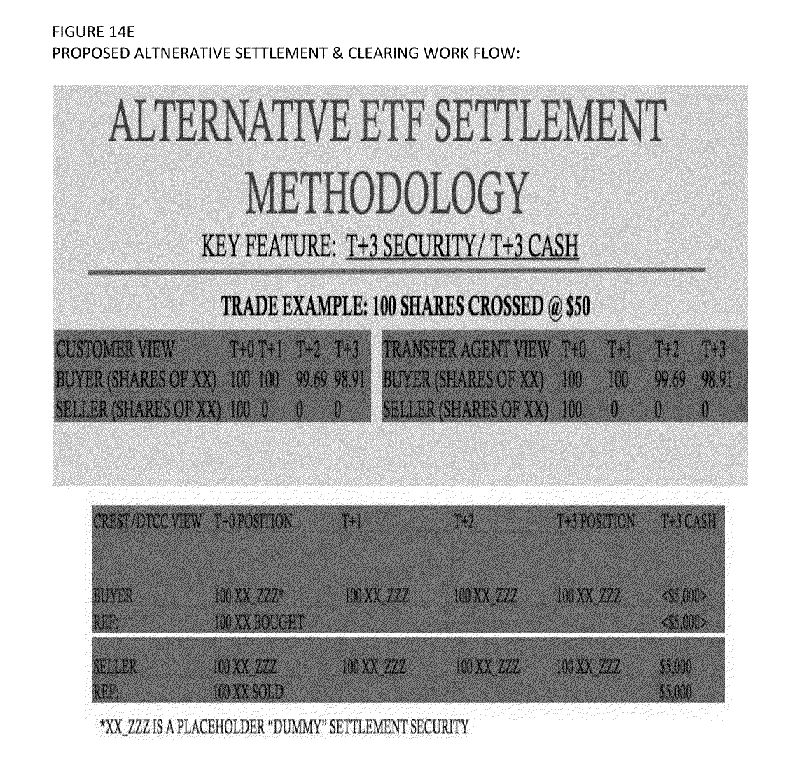

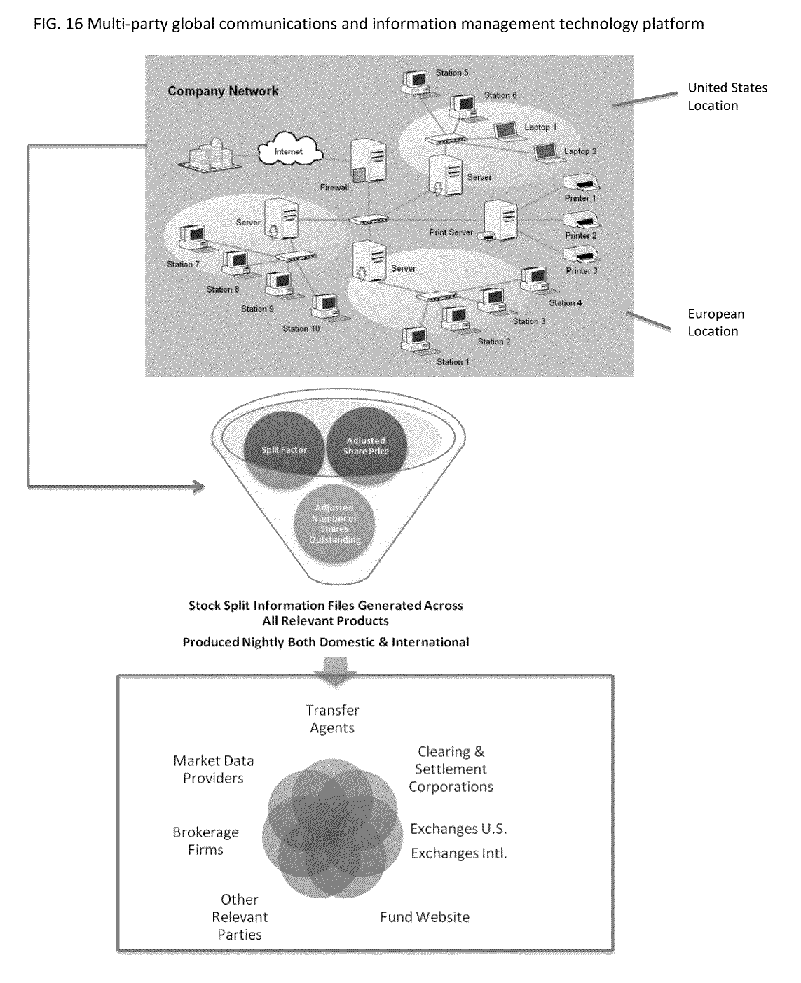

The novelty and uniqueness of the daily stock split feature is reinforced by the fact that DTCC does not currently clear and settle any product that is subject to a daily stock split, even though they settled nearly $US 1.66 quadrillion in securities transactions in 2010. Further, one of the potential challenges associated with the unique and novel daily stock split element is that buyers and sellers would face settlement breaks on settlement day (typically three days later), because the adjusted number of shares that they would own three days later would be impossible to predict in advance. They wouldn't be able to enter within their settlement system on trade date the number of shares they would have to settle three days letter as the shares on trade date would be subject to multiple stock splits before settlement. With traditional stock splits, the split can occur once and investors would know exactly how many shares they would have three days later. However, with the present inventive system, the shares are not subject to a traditional split; at least a second, additional split occurring on the day after trade date would be required. One novel solution to this problem involves having the clearing and settlement entity cancel and replace the trades each day, over multiple days as shown in FIG. 14B. Such a system can require a rapid end of day calculation of the required corporate action stock split or reverse split so that it can be provided to the clearing entity by the time they effect their nightly settlement process. Such processes typically start by 9 pm on Trade Date. Thus, there would only be a 5 hour window when trading ends on the product (for example 4 pm EST), and when the Fund N.A.V. and new share balance would have to be calculated and transmitted to the clearing corporation. The data associated with this information would need to stored electronically in a computer file and transmitted over a communications network to the clearing and settlement corporation, for example, either via FTP (file transfer protocol) or email. As the product can be listed and traded internationally, other various messaging services can be used, including but limited to SWIFT. CREST is the name of the clearing settlement organization in Europe. To facilitate international trading, a multi-party global communications and information management technology platform can be designed, created and maintained to support the determination and dissemination of daily stock splits associated with ETFS when the products are listed individually or dual listed around the world in multi-time zones comprising at least the fund companies, the clearing entities, the transfer agencies, the brokerage firms and investors as shown in FIG. 16.

The novelty and uniqueness of the Shareholder Adjustment Factor feature is demonstrated by the fact that the Depository Trust and Clearing Corporation (DTCC) which provides custody and asset servicing for more than 3.6 million securities issues from the United States and 121 other countries and territories does not presently support the inventive embodiment. Substantial software modifications would be required. As a result, an exchange traded version of the product would embody a SAF or not embody a SAF now or in the future, depending upon the ability of firms to clear and settle transactions associated with such a factor. Brokerage firms are also not familiar with nor technologically prepared to display an equity pnl or position value calculation associated with a SAF in their customer accounts. Such clearing firms and brokerage firms can apply a software modification to display the SAF. Another variation might be calling the SAF by another name or using multiple factors that provide the same general functional equivalency.

There is also currently no product (such as an ETF) where a defined subset of the portfolio of the product subjects different investors to different stop loss trigger events, and whereby each event is determined by the Fund Administrator (and not the individual investor of the Fund). It would be helpful to provide an investor with an automated method of reinvesting capital received that was triggered by a stop loss in such a financial product. For example, in the parent application, an example was given of a stop loss event initiated by the Fund requiring investors to receive money if one of their linked swap positions was stopped out. Investors may not have the time to receive a notification of the cash received, determine the next available closing price and then reinvest capital through a manually entered order. In an embodiment the instant invention provides an automated method for re-investment of capital received through a stop loss trigger event, even on the same day as the stop loss event or other periodic time period (such as hourly, real-time, etc).

In order to create the preferred embodiment of a single ticker security XX, the portfolio would likely require additional swap contracts as the market moves up (assuming that new capital enters the fund as it rises). For example, a 33⅓% up movement would require the fund to have, as an example, 4 swap contracts when a new investor purchases the Fund XX at a level at about 1,333. Alternatively, a Fund of Funds portfolio can be designed, created and then managed that would synthetically replicate the performance of a swap, including but not limited to investing 50% of the initial assets in a 1×SP500 ETF product and 50% in a 3× total return SP500 ETN. The below example shows how the Fund would require additional swap contracts as the underlying Index rises and an adjustment in the product's stop loss mechanism.

### Day 1 Index Level 1,000:

One shareholder (Shareholder A) places an order to own $1,000,000 of XX.
XX Fund Administrator purchases two total return swaps:

Swap “XXA” with a fixed leverage of 1 with an initial notional of $500,000

Swap “XXB” with an initial leverage of 3 with an initial notional of $500,000

Day 2: The market then rises to an Index Level of 1,333.
A second shareholder (Shareholder B) decides to buy $50,000 of XX
XX Fund Administrator purchases two new total return swaps. As XXB has an implied delta of almost less than 2.0, a new set of swaps (or other leverage-able securities) can be purchased. The two new swaps owned by XX are:

Swap “XXC” with a fixed leverage of 1 with a notional of $25,000

Swap “XXD” with an initial leverage of 3 with a notional of $25,000

XX Fund Administrator thus has two shareholders with 4 swaps at a level of 1,333.

Swap XXA with a fixed leverage of 1 with a notional of $500K

Swap XXB with an initial leverage of 3 with a notional of $500K

Swap XXC with a fixed leverage of 1 with a notional of $25K

Swap XXD with an initial leverage of 3 with a notional of $25K

What happens if the market then drops 33.33% from 1,333 on Day 2 to 888.91 on Day 3?
As Shareholder B cannot lose more money than he has invested, the Fund will automatically stop/loss him at a defined level approximately less than or equal than −33⅓% of the 1333 level. This would prevent the fractionalized share value of his 3× swap (XXC) from going negative and would approximately equal a terminal Index level of 888.91.

In order to incorporate a stop loss feature, managers of the fund invest in a portfolio of securities by applying mathematical formulas required to achieve a target leverage weighting solution. Using the SP500 as an example, this can involve identifying or create two separate products to invest in; a 1×SP500 product which will be called XXA and a second levered product that holds a 3× total return swap based upon the SP500, which will be called XXB. If the S&P500 is the underlying Index, then the formula to derive how the leverage of each Leveraged Product will change in response to the Index is:

L(t)=L*I(t)/[(L*I(t)−I(o)+I(o)]

The formula to derive how the weighting of the product changes for investors who purchase after the first day is:

XXA W(t)=[2−XXB L(t)]/[XXA L(t)−XXB L(t)]
Weighting of ETF: W(t)
Leverage of XXB: XXB L(t)
Leverage of XXA: XXA L(t)
   The below model describes the mathematical relationship between an ETF linked to the performance of a leveraged Index. There is no rebalancing or compounding of leverage.

Initial Price of ETF: Pt=It

Daily Calculation: Pt+1=Pt+[It+1−It−1*R*L]

Final Price of ETF: PM=It−IM−financing costs

wherein
Pt=Price of ETF at inception
It=Price of Index at inception
PM=Price of ETF at maturity
IM=Price of ETF at maturity
R=Initial Index Price at To/Po (Constant)
L=Leverage Factor (Constant Value)

For example, an index begins on day 1 at 1000. On Day 2, the index has moved up 2.5% to 1025. Security XXB, which had a leverage factor of 3 on Day 1 now has a leverage factor of 2.860465116. The calculation of the new leverage factor is performed using the below formula:

L(t)=L*I(t)/[(L*(I(t)−I(o))+I(o))]

To result in an exemplary calculation of:

2.860465116=(3*1025)/(3*(1025−1000)+1000)

As the leverage decreases from 3.0 to 2.86 as the index has increased, a new investor (Investor B) must now purchase more of security XXB in comparison to security XXA to receive a weighted average leverage of 2.0. A new investor must now allocate 53.75% of capital to security XXB and 46.25% to security XXA. The weighting on any given day for security XXA is calculated using the following formula:

(Target Leverage−Current leverage XXB)/(Current Leverage XXA−Current Leverage XXB)

In this example, the 0.4625 is calculated as follows:

(2−2.860465116)/(1−2.860465116)

which can be displayed in percentage form (46.25%)
The weighting on any given day for security XXB is:
1−XXA weighting
   To result in an exemplary calculation of:

0.5375=1−0.4625

Other advantages of the present invention can include:

A) Providing investors with a ‘same as margin performance’ with a potentially lower cost than buying on margin. The cost to operate the ETFs can be extremely cost competitive to investors who would otherwise have to pay the broker call rate (which is currently over 4%).
B) The ETF XX can be used as a wrapper to buy intra-day a portfolio of securities that are not listed on an exchange and transform at the end of the day into two securities (other variations are possible including more or less than two) who performance is linked to those securities. For example, there are thousands of managed mutual funds with over $11.5 trillions of dollars of assets that are not listed on an exchange. Under one embodiment, the leveraged (or in an alternative embodiment non leveraged) ETF can transform into two or more products that provide a leverage return profile linked to the value of the OTC product at the end of the day, week or month or other user defined period of time (such as hourly, intra-day or in real-time) even after a stock split or reverse split occurs.
C) Allowing an investor to buy an exchange traded product providing non path price dependent leverage on restricted securities, illiquid securities, hybrid securities, non-deliverable forwards, single stocks, ADRs and other investable and non-investable asset classes including but not limited to commodities, agricultural products and metals, currencies and other securities as discussed in Appendix A, below.
D) Daily Leveraged and Inverse ETPs with no tracking errors caused by price path dependency, compounding or leverage drift.
E) The performance received is the performance expected in both rising, falling and trending markets.
F) Investors can use the product as a a delta hedge.
G) Options traders can more effectively hedge their delta, gamma, theta, rho and other greek exposure risk to an underlying index.
H) Fund managers, and other professional investors are not subject to front running (which current daily leveraged ETP providers are exposed to as they need to rebalance their portfolios at the end of each day).
I) Investors, which includes Fund Managers, can buy options on the ETP (XX) which can deliver into one or more fixed, non path dependent products (XXA, XXB individually or in combination).
J) A class of shares (or multiple classes) can be listed on the leveraged products. Each or all of these classes can be subject to a daily split or reverse split.
K) The portfolio can be displayed either partially, in full, or not at all, on a delayed or real-time basis.
L) Investors are not forced to buy and sell their fund shares on a daily basis to maintain fixed leverage, allowing them to receive long term capital gains treatment (if their investments go up).
M) Each of the one or more leveraged products in the preferred embodiment can have a stop loss feature to ensure that investors do not lose more than their initial investment, whether mandatory or optional.
N) Investors will have a single security product that they can trade in and out of during the day. If they hold the product overnight, even after a stock split, they can instruct the fund to redeem their shares for the portfolio of securities owned by the fund (for example XXA and XXB) will appear in their brokerage account. Investors can keep their new ETP positions (XXA & XXB) or sell them at any time on the open market the next business day or directly to the Sponsor.
O) No path dependency can equate to Longer Holding Periods which can equate to more revenue for Fund Sponsors. Because of the superior tracking of the underlying Indices overtime, investors can consider changing their investor behavior and hold the proposed products for long periods of time, generating more revenue for the sponsors.
P) Investors can receive a ‘set and forget’ constant leverage exposure (to a benchmark or index, for example) providing a more compelling user experience than having to actively manage their position at the end of each day.
Q) By listing a leveraged ETP on a single stock like IBM, investors can achieve a unique method of gaining leverage over traditional options on stocks. One of the unique attributes of the preferred embodiment (XX) includes avoiding the theta risk and time decay inherent in the option pricing models of options on stocks. For example, instead of having to be right on both the direction AND the timing of when the security moves, an investor in XX needs only to be correct as to the price movement of the underlying index or benchmark (taking into consideration the built in stop loss feature). Note that options on an ETP linked to a performance of IBM, however, can be subject to theta and time decay.
R) By listing a leveraged ETP on a single stock like IBM, investors can achieve a unique method of gaining leverage over single stock futures. With single stock futures, an investor opens a margin account and (currently) pays higher capital gains taxes on profits if held for more than one year. In addition, futures investors ‘roll’ their positions over at contract maturity, contributing to increased brokerage and trading costs. With a leveraged ETP on a single stock, no margin account would be required, there would be lower capital gains on profits if held for more than one year and no requirement to roll positions.
S) Various strategies can be employed with the present invention, including tax loss harvesting (sell a highly correlated security to the ETP and lock in the loss, then buy the ETP), convertible arbitrage, dividend arbitrage, high frequency trading, relative value (short a price path dependent leveraged ETP and buy the proposed non-price path dependent leveraged ETP, long/short, fundamental pairs trading, etc.

Accordingly, it should be emphasized that the above-described embodiments of the present invention, particularly, and “preferred” embodiments, are possible examples of implementations merely set forth for a clear understanding of the principles of the invention. Many variations and modifications can be made to the above-described embodiment(s) of the invention without substantially departing from the spirit and principles of the invention. For example, instead of having a creation process occurring at the end of the day for security XX, it can occur in real-time or intra-day.

The related steps for creating an Exchange Traded Product in accordance with the present invention can be inclusive of:

A. Filing a prospectus and/or registration statement with the S.E.C. (or comparable foreign government agency).

B. Registering the product under Investment Company Act of 1933, 1934, 1940 (or other domestic and/or foreign Act(s) and sections as required) as well as receiving exemptive relief from relevant sections.

C. Have an issuer or Sponsor create the product and receive a CUSIP, ISIN or other security identifier (from a clearing or settlement company, for example).

D. Listing the product on an exchange (or off the exchange, for example, on an electronic matching platform, electronic trading platform, screen based trading system, dark pool, ECN, third market, OTC market, upstairs trading, phone execution).

E. Allowing Investors to place orders to buy or sell the products at agreed upon prices either electronically or non electronically.

F. Market makers (or sponsors) buy and sell the product by posting bid and ask prices.

G. Market makers (or other investors) execute a hedge to their purchases and sell the product by buying or selling the underlying, a linked derivative security or correlated security, benchmark or otherwise acceptable hedge or arbitrage prescription.

H. Settling the product at the end of the day with a settlement price, estimated Net Asset Value (NAV), NAV or Indicative NAV.

I. Have the issuer or sponsor Create/Redeem product from authorized market participants (either market makers, retail or institutional investors) on a user defined time interval, including real-time, during the day, intra-day, close of day, weekly, monthly, yearly, multi-yearly for a defined amount of shares, units, contract, nominal or dollar value.

J. Display portfolio and its component values, broken down into one or more pieces in humanly readable form, fully or partially for some or all participants to see (in real-time, intraday, daily or delayed) including delivery basket, residual cash, intraday indicative value (IIV), hedging basket, creation basket, redemption basket, net asset value, interest, factor, financing, security or security holdings (whether displayed in full, partially or not at all), referenced assets, index or indices (whether estimated or actual) on an intraday, real-time basis, delayed and/or as well as closing day basis.

In addition, an index can be created based upon such requirements that the index be limited to just one benchmark or investable security, such as an equity (i.e. IBM), an ETF, an ETN, an ADR or a derivative. Another benchmark or index variation or ETP structure can be one that is based upon one or more asset and sub asset classes, including but not limited to leap options, each of which are exercise-able either individually or in combination into one or more securities (such as those securities found below in Appendix A)

Alternative structures can be used besides an ETF, including a Trust (including a business trust, grantor trust, unit investment trust) and/or a fixed income product including an exchange traded note, security, bond, using a conversion or convertible or exchangeable or Paid in Kind (PIK) feature or a security listed below in Appendix A. Alternative portfolios can also be invested in such as those listed in Appendix A or Appendix B, including a combination of leveraged and or non-leveraged securities.

### Definitions

ALL terms should be given their ordinary meaning The applicant is not acting as his own lexicographer, even in the below section titled “For purposes of clarification only”. To the extent a term or phrase requires extrinsic evidence to determine a definition, I claim the Barrons Dictionary of Finance and Investment Terms, 8^{th} Edition.

For purposes of clarification only:

Split or Splitting: The term “split” or “splitting” of shares are used within the specification to generally refer to increasing the number of outstanding shares in a product without any change in the shareholders equity or the aggregate market value at the time of the split with a corresponding decrease in the share price. A synonym for a stock split is a “split up” or “stock divide”.

Reverse Split: A reverse split generally refers to a procedure whereby a product reduces the number of shares outstanding with a corresponding increase in share price. The total number of shares will have the same market value immediately after the reverse split as before it, but each share will be worth more. A reverse split is also known as a split down.

The product can also be split or reverse split on a user defined time basis, such as intraday, every two days, every three days, every fourth day, once a week, once a month, once a year, or if a specific target price or price movement is reached, or any combination thereof. A split or reverse split factor file can be generated nightly with a signal number to indicate no split (i.e. 1 or 0). If the product tracked a particular index or benchmark and that index or benchmark was unchanged for the day, the product sponsors could still choose to adjust the shares in response to the daily management fees incurred by the product.

ETP: The term ETP generally refers to an ‘exchange traded product’ and is meant to be broad and inclusive of any product that can be traded or exchanged on an exchange or on an electronic trading platform, including but not limited to match trading, auction trading, give ups, exchange for physicals, and or two sided trading. An ETP can be inclusive of at least leverage access securities, exchange traded securities, exchange traded asset back securities, exchange stock portfolios, exchange portfolios, exchange index securities, exchange traded funds, exchange traded commodity pools, exchange traded trusts of any nature, closed end funds or a product similar to or equivalent to an exchange traded note (ETN) or any exchange traded derivatives, including but not limited to swaps, options or futures. An ETP can be traded within or without a margin account.

ETN: An ETN is similar to an ETF but holds, instead of a portfolio of stocks, a senior unsecured (or secured) debt instrument that promises to repay the principal amount adjusted by applicable fees and by the performance of a specified index, benchmark or investment objective.

Exchange: An Exchange does not have to be limited to an SRO, which is a self-regulatory organization or a national securities exchange. It is important to note that exchange traded products can be traded off an exchange.

Shares: The term “shares” generally refers to a unit of equity interest or ownership. Thus, a share should be understood to be inclusive of, but not limited to, an ownership unit of an ETP or non ETP and or other products that offer for sale a fractionalized (or unfractionalized) ownership interest, including but not limited to identified shares.

Open End: When used in conjunction with an ETP, an open end product can be traded at mutually agreed upon prices that differ from the net asset value.

Appendix A, B: Appendix A and B are not merely lists but carefully researched compilations of relevant financial and investment terms that can be used as an aid in at least designing and creating, or managing an ETP or non ETP. Instead of listing hundreds of pages of the various combinations, the individual items are listed and can be combined in myriad ways as required.

For purposes of an example only—and not as a limitation to past, present or future applications or inventions, three common types of leverage that can be used by an ETP and/or its portfolio manager and/or its investors are:
1. Financial Leverage: Created through borrowing leverage and/or notional leverage, both of which allow investors to gain cash-equivalent risk exposures greater than those that can be funded only by investing the capital in cash instruments.
2. Construction Leverage: Created by combining securities in a portfolio. How one constructs a portfolio will have a significant effect on overall portfolio risk, depending on the amount and type of diversification in the portfolio, and the type of hedging applied (e.g., offsetting some or all of the long positions with short positions, short selling, shorting, short investments such as futures or other derivatives (e.g. puts, calls, total return swaps, caps and floors, warrants, etc.).
3. Instrument Leverage: Reflects the intrinsic risk of the specific securities selected, as different instruments have different levels of internal leverage (e.g., $100,000 invested in equity options versus $100,000 invested in government bonds).

Leverage can be quoted as a ratio of assets to capital or equity (e.g., 4 to 1), as a percentage (e.g., 400%), or as an incremental percentage or fraction (e.g., 350%). In addition, BETA can be used to determine the level of leverage using by calculating, for example, Levered Beta. Leverage can be quoted as an inverse as well such as short 100% or short 150%.

### DETAILED DESCRIPTION OF THE DRAWINGS

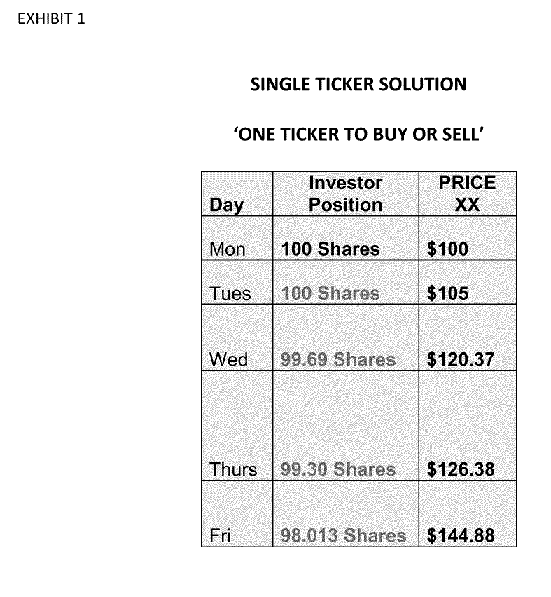

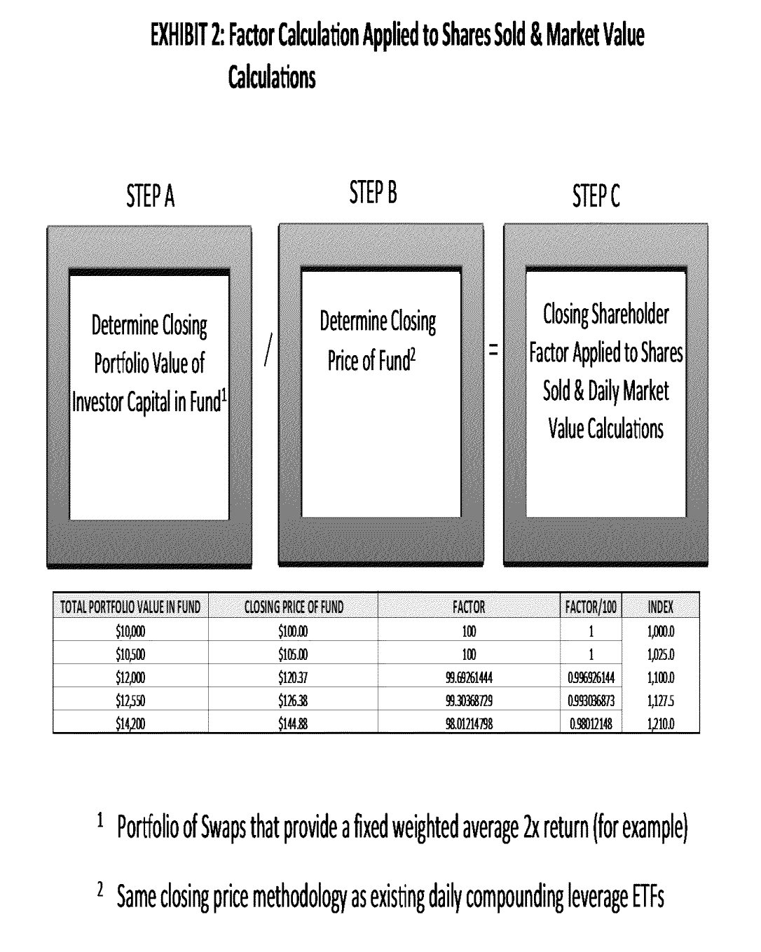

FIG. 1 (EXHIBIT 1) depicts the position of an investor who owns a single ticker product over time. The investor has changing number of shares in his account over time as a result of the product undergoing a daily stock split in response to a change in the index. In this example, the Shareholder Adjustment Factor is not shown.

FIG. 2 (EXHIBIT 2) expands upon FIG. 1 by depicting step by step how a Shareholder Adjustment Factor is calculated in conjunction with an investor who owns Fund XX. In STEP A, the fund determines the closing portfolio value of all investor capital in the fund, which initially begins with $10,000. The $10,000 is invested by the fund into a portfolio of swaps that provide a weighted average leverage of 200%. In STEP B, the fund determines the closing N.A.V. of the fund, which is the same closing price methodology as existing daily compounding leverage ETFs. It is twice the return of the daily price change of the index. For example, when the Index rises from 1,000 to 1,025, the closing price of the fund is $105. And when the Index then rises from 1025 to 1,100, the closing price of the fund is $120.37. This 20.37% two day rise in the price of the fund is contrasted against a 20% two rise in the value of the funds assets. In STEP C, a closing shareholder factor is calculated by dividing the total portfolio value of the fund by the closing price of the fund on a daily basis.

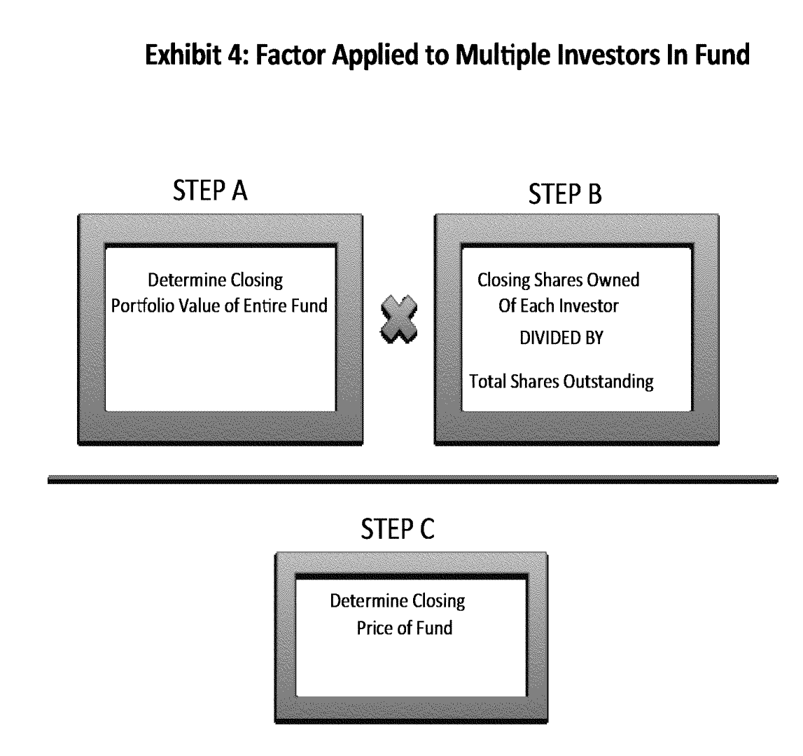

FIG. 3 (EXHIBIT 3) depicts how a calculated Shareholder Adjustment Factor value is applied to determine a market value for a single investor position. In STEP A, the closing number of shares owned by an investor is determined. For example, 100 shares are displayed in an account. In STEP B, a factor (SAF) is displayed next the number of shares. Initially, the factor is 1. In STEP C, the number of shares owned is multiplied by the factor to provide a closing shareholder daily market value calculation. For example, 100 shares owned multiplied by the closing price of $100 multiplied by 1=$10,000. After the index rises 21% to 1,210, the closing shareholder market value is calculated by multiplying the original shares owned of 100 multiplied by the current factor of 0.980212148 multiplied by the closing price of the fund of $144.88 to result in a total market value of $14,200, which is exactly twice the return of the index (42%).

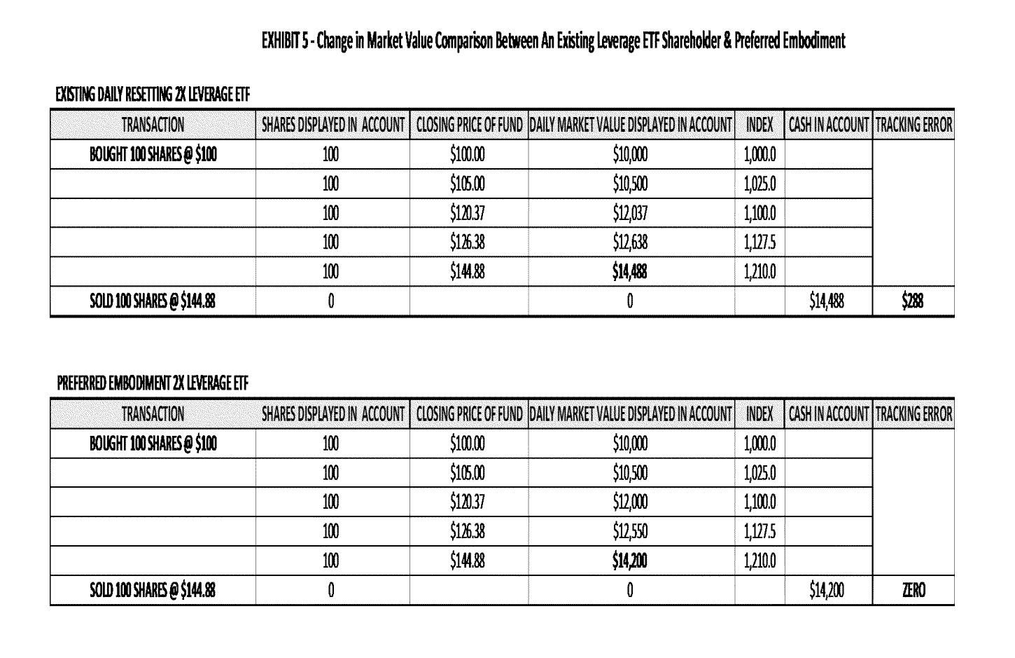

FIG. 4 (EXHIBIT 4) depicts how a calculated factor value is applied to determine a market value for investor positions. In STEP A, the closing portfolio value of the entire fund is calculated. In STEP B, the closing share position of each investor is divided by the total shares outstanding. The results of STEP A and STEP B are multiplied together and subject to division by STEP C, which is the closing price of the fund.

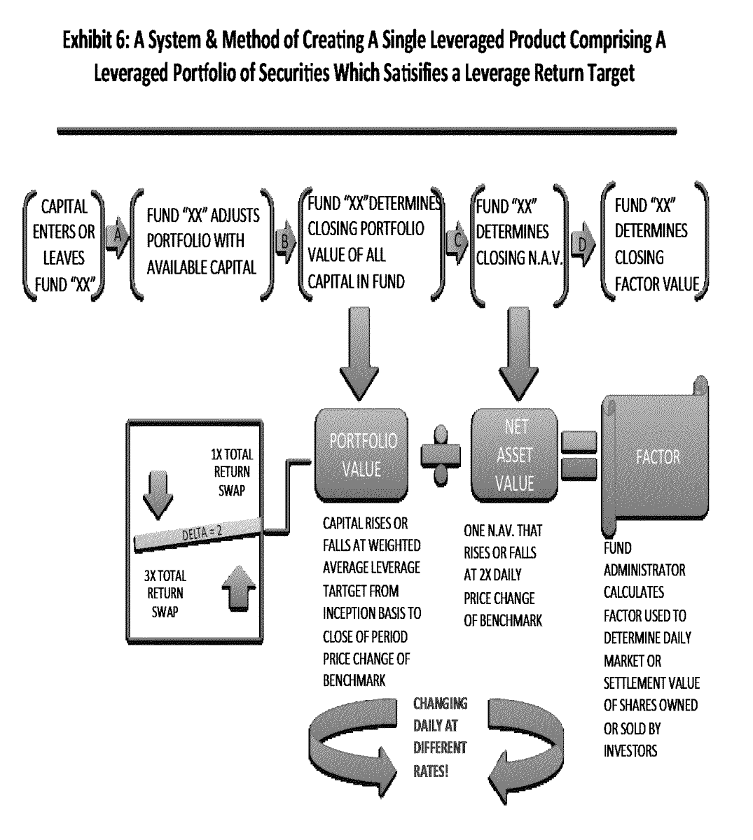

FIG. 5 (EXHIBIT 5) compares and contrasts how the purchase and subsequent sale of existing leveraged ETFs and the inventive preferred embodiment result in two different cash balances. The ‘EXISTING DAILY RESETTING 2× LEVERAGE ETF’ cash balance has a tracking error of $288. The ‘PREFERRED EMBODIMENT 2× LEVERAGE ETF’ provides the investor with zero tracking error.

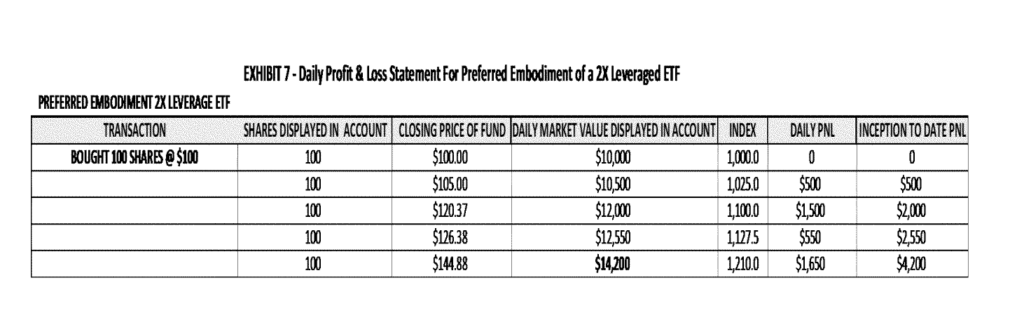

FIG. 6 (EXHIBIT 6) depicts how the portfolio value of the product will change at a different rate than the N.A.V. price. The PORTFOLIO VALUE Box is calculated based upon a portfolio of swaps that provide a weighted average leverage return. The NET ASSET VALUE Box is the settlement price of the fund, which rises or falls at twice the daily price change of the benchmark or index. Note that this is not a traded price—it corresponds to twice the daily return of an index. The factor is determined by dividing portfolio value of the product by the N.A.V. of the product.

FIG. 7 (EXHIBIT 7) depicts a stable share balance of 100 in a pnl statement, even though the share balance is changing daily.

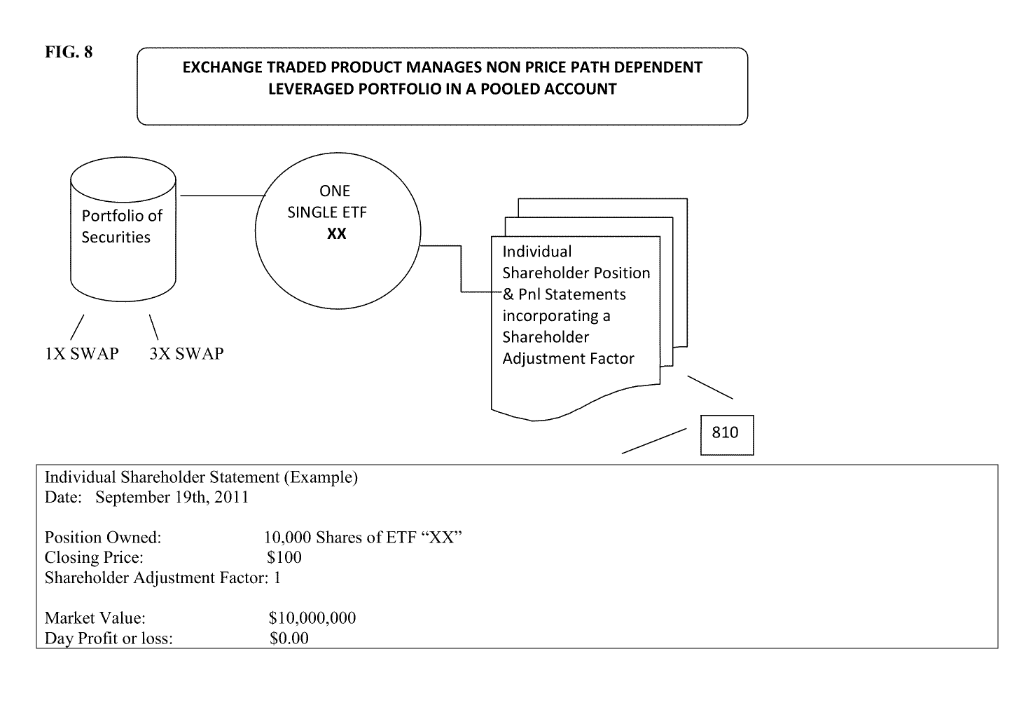

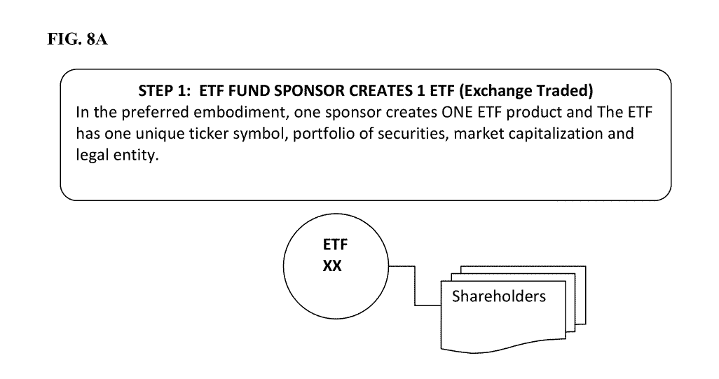

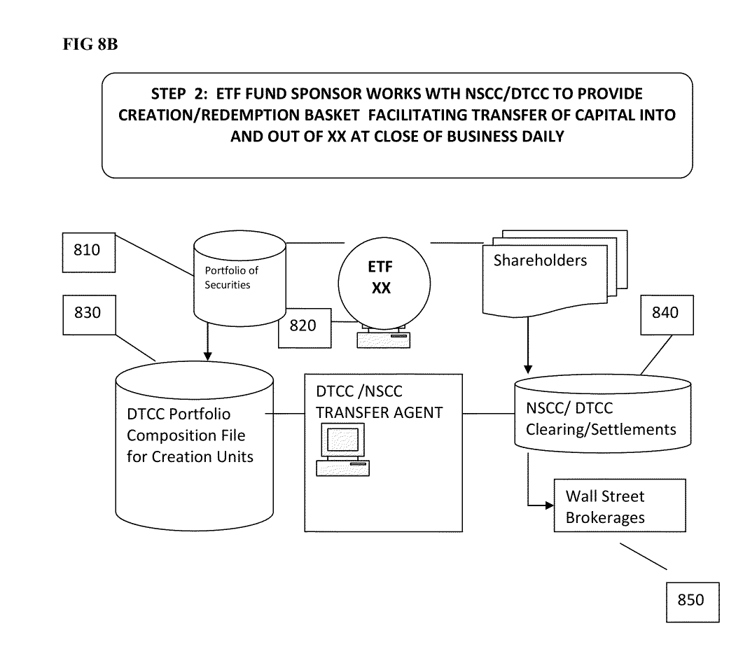

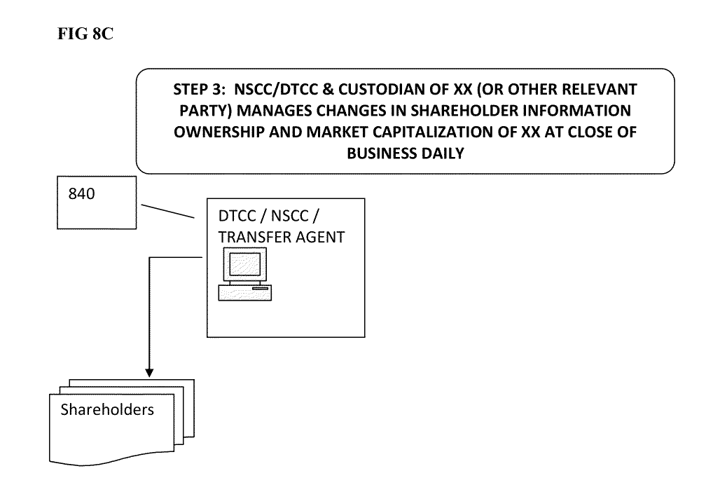

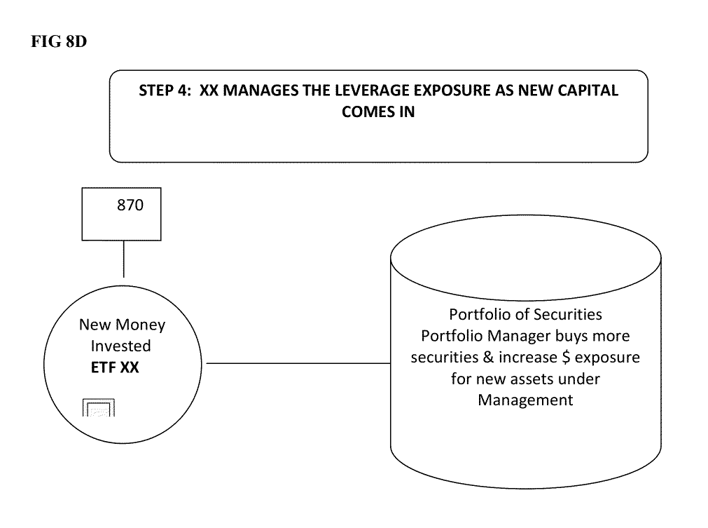

FIGS. 8-8C depict a creation/redemption process occurring XX in real-time or intra-day by using the following steps:

1. A person who owns either a unit or share of the underlying ETN or ETF or related structure provides the group responsible for creations and redemptions, including but not limited to authorized participants, the custodian, exchange, clearing corporation, department, market marker, issuer and/or brokerage firm, with an electronic notification that they wish to create or redeem shares intra-day. The notification can have several different execution choices, including creating or redeeming at a specific price related to the underlying security that is held by the ETN or ETF (or other ETP), bid/ask, spread, or algorithmic mathematical relationship, for a defined time period (including sub-second, seconds, minutes, hours, daily, weekly, monthly, yearly or user defined period).
2. In the case that a creation order had been placed, an electronic transfer occurs into or out of the account of the entity or person who placed the order for securities that represent the dollar amount requested to be created.
3. In the case that a redemption order has been placed, an electronic transfer occurs into or out of the account of the entity or person who placed the order for securities that represent the dollar amount or value requested to be redeemed.
4. All of the above steps can use computers to store information relating to the ownership of shares, computer code instructions to add and subtract shares from relevant brokerage and clearing accounts, including but not limited to DTCC, NSCC, CREST, Transfer Agents, Custodians, Exchanges. One of the benefits of allowing intra-day creation/redemptions is that arbitrageurs can lock in profits immediately and reduce their balance sheet usage during the day. This allows them to make more money as they can trade more products during the day.

Turning specifically to FIG. 8B, at reference number 810 a Fund Sponsor calculates using a portfolio management computer system the closing market capitalization of fund XX by valuing a portfolio of securities held. At reference number 820 the Fund Agent (e.g. Sponsor, Administrator, Custodian, Transfer Agent, Investment Adviser, Sub Adviser or Board Of Adviser) calculates the leverage and weighting proportion required to provide shareholders at the close of each business day with an ongoing fixed, constant leverage consistent with the closing market price of XXA and XXB. At reference number 830 the Fund Agent of XX provides DTCC with portfolio composition file and/or shareholder information that can be redeemed into) XXA, XXB. This information is also displayed directly and through market data vendors to authorized participants. At reference number 840 the DTCC clears and settles trades, and updates shareholder information in conjunction with Transfer Agent. At reference number 850 each individual shareholder position is updated and processed electronically, then sent to Brokerage firms.

Turning specifically to FIG. 8C, at reference number 840 Fund Sponsor XX is informed by DTCC/NSCC/TRANSFER AGENT and/or Fund Sponsor XX of the new shareholders and capital inflows/outflows.

Turning specifically to FIG. 8D, at reference number 870 Fund Sponsor XX receives more capital. XX Maintains leverage of 200% to SP500 but increases the dollar ($) amount of exposure by the amount of new capital that comes in. Moreover, if redemptions occur from XX, then the amount of exposure would decrease. Also, with regard to the steps shown in FIGS. 8A-D, the steps can occur in any order and can be repeated at user defined time periods either separately or in combination.

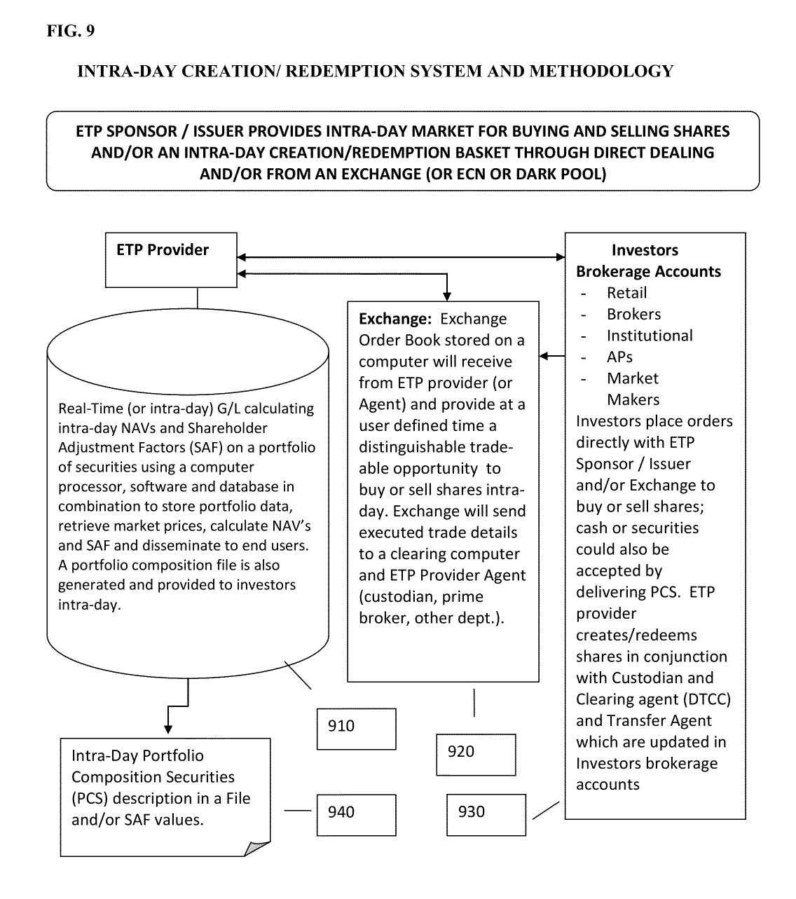

FIG. 9 illustrates how an intra-Day Creation/Redemption process is made possible by an Exchange Traded Product Sponsors/Issuers through Direct Dealer/Market Making In FIG. 9 one-step for making an intra-day creation/redemption process work is by having a robust (in one embodiment real-time) general ledger capable of striking multiple intra-day NAVs as shown in Box 910. Once the NAV has been calculated, a trade-able opportunity in the form or either a price (or non trade-able indicative price range might be posted in the order book on the floor of the exchange) as shown in Box 920. Otherwise, no price would be displayed and investors would not receive the price until after their order was placed and settled. If no price is displayed, an alternative placeholder such as “NAV” might be displayed. Alternatively, the Investor can review the portfolio composition file as shown in Box 940 and submit the creation/redemption request directly to the ETP provider as shown in Box 930.

One of the disadvantages of the current end of day creation/redemption process is that intra-day market makers may back away from making markets in ETFs (for example) during large volatility swings, as evidenced by the ‘flash crash’ of 2010. To mitigate the liquidity risk taken by investors during the day, ETF fund sponsors can generate real-time market liquidity by acting as direct dealers during the day. By striking intra-day NAVs in real-time, on an hourly basis or other user defined period intraday, ETP sponsors can reduce the premium or discounts during the trading day as well as the trading friction costs incurred by investors imposed by bid/ask spreads on the exchange floor. The key to making an intra-day creation/redemption process work is by having a robust real-time general ledger capable of striking multiple intra-day NAVs as shown in box 910. Once the NAV has been striked, or in the case of an ETN, an alternative price indication of what the issuer would accept to redeem or create, a trade-able price can be posted in the order book on the floor of the exchange as shown in box 920. Alternatively, the Investor can submit the creation/redemption request directly to the ETP provider as shown in box 930. The preferred embodiment is an ETF Sponsor/Issuer that can provide securities in lieu of cash in the creation/redemption process to maintain tax efficiency. Other variations are possible, such as allowing institutions to trade the product at or close to NAV amongst themselves through an electronic platform not located on a national securities exchange. Other variations are also possible, such as ETPs that provide cash in lieu of securities, but they may not be as tax efficient (which might necessitate the need to create a separate class of shares). The creation/redemption process can be followed by a notification of the change in shareholder positions to a clearing/settlement entity, either by the ETP provider or the exchange, as well as settlement of securities and/or cash to/from the Investor brokerage account. Two embodiments for the framework that illustrate an automated method of enhancing intra-day liquidity are graphically illustrated. It should be noted that the preferred embodiment is where the Investor executes a trade on an exchange by buying or selling at a trade-able price, the price distinguishable by other prices identified being offered. The distinguishing characteristic of the price can be an association of a corresponding code, such as a Broker Code, that represents the ETP provider or agent thereof. However, other variations are possible, such as having investors consider the N.A.V. and trade the Fund directly between themselves off the floor of a national securities exchange, such as through an electronic trading platform, either at the N.A.V. or a close to it. In addition, investors can create and redeem ETF units by trading directly on the platform against on-screen prices based on the N.A.V. Intra-day and/or cross auction trading of the product can also be done by investors, including a dark auction on the platform. Alternatively, it can be done on an exchange or off the exchange in a different venue, such as in the OTC market.

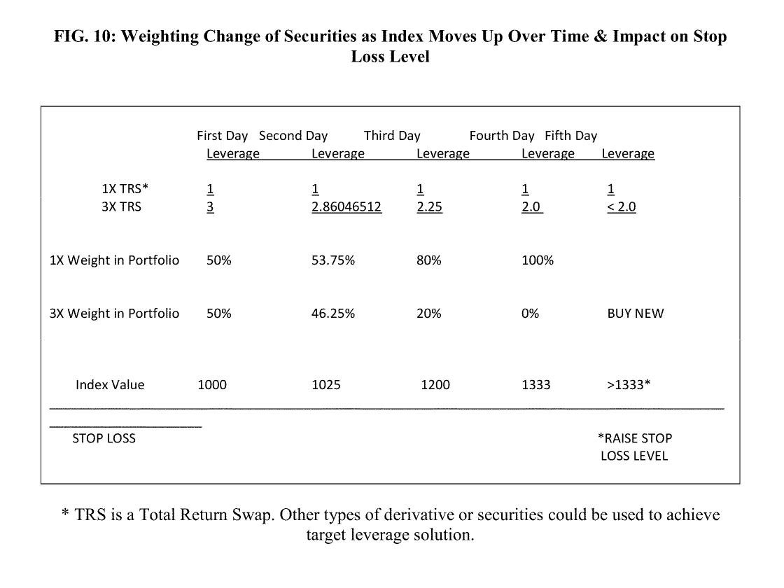

FIG. 10 depicts the weighting change of securities as the index moves up over time and the impact on a built in stop loss level. For example, when the index rises more than 33%, the fund would require a new 300% (3×) total return swap as the implied leverage would drop below 200% (2×). Therefore, the fund would be forced to increase raise the stop loss level approximately less than or equal to −33⅓% of the 1333 level. This can prevent the fractionalized share value of his 3× swap from going negative and would approximately equal a terminal Index level of 888.91. Thus, for every predetermined percentage movement up, the stop loss level could have to be raised.

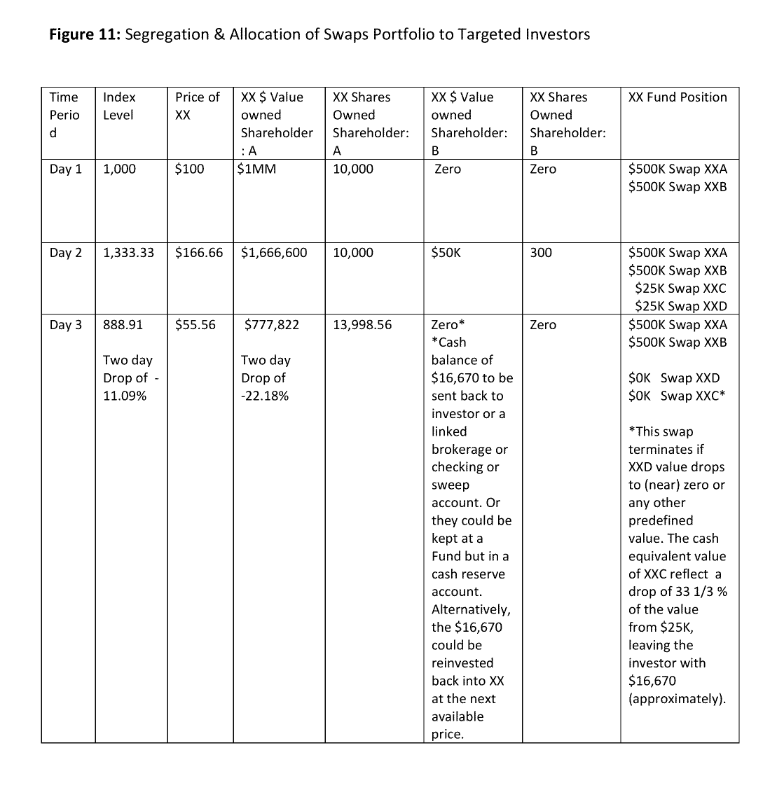

FIG. 11 depicts how to segregate and allocate of swaps portfolio to targeted investors. As shown in FIG. 11, the Fund is able to segregate the 2^{nd} set of Swaps from impacting he first shareholder, Shareholder A. By applying fund accounting software, the XXC/XXD swaps were allocated to the second shareholder—not the first. This accounting treatment allows different investors to get stopped out based upon their unique entry point to the XX Fund. Thus, as the Fund swings sharply in value, multiple stop loss triggers can be affected—but only for the relevant investor set. This unique feature will allow an unlimited number of investors to buy XX at any price point—and still maintain a single ticker product for both purchases and sells. It is also a way to prevent liquidation (or redemption, termination or distribution) of the entire fund when a stop loss event is triggered for just a portion of its portfolio—only those shares held by the subset of investors affected by the stop loss event. LIFO is one example of many of an accounting methodology that can be used to redeem the shares held by the affected investors. Once the stop loss trigger is initiated, impacted investors can either reinvest the capital manually or enter into an agreed upon automated reinvestment. The Fund (or an agent or brokerage firm) can flag the investor account so that any monies received from a stop loss event can automatically be reinvested in the Fund at the next available price. The current invention can be tied to a stop loss event that may never occur, or can occur with substantial frequency (i.e. more than once a month or quarter), depending upon volatility of the underlying Index it tracks. In addition, in one embodiment, it can be based upon the performance of a portion of the investment portfolio, not necessarily the entire portfolio. Alternatively, the entire portfolio can be subject to a simple peak to trough defined stop loss trigger. In other words, for every 33⅓ movement up, the entire portfolio can be subject to a maximum drop of 33⅓ before stop lossing all shareholders, based upon the most recent peak. The movement up can be based upon one or more benchmarks, including but not limited to: a) the price of the product b) the price of the underlying benchmark c) the value of the portfolio d) the market capitalization of the fund and or e) a user defined value. It can also explicitly state that the movement up stop loss trigger can not be based upon the closing price of the product but only on a rolling percentage or price movement of the index, or any other combination of (a) through (e).

It is important to note that a Swap is an embodiment of a derivative security within the portfolio comprising XX, but not necessarily the only possibility. Many other security types, security groups, financial products are possible, including but not limited to a fund of funds, non derivative securities and those illustrated within Appendix A.

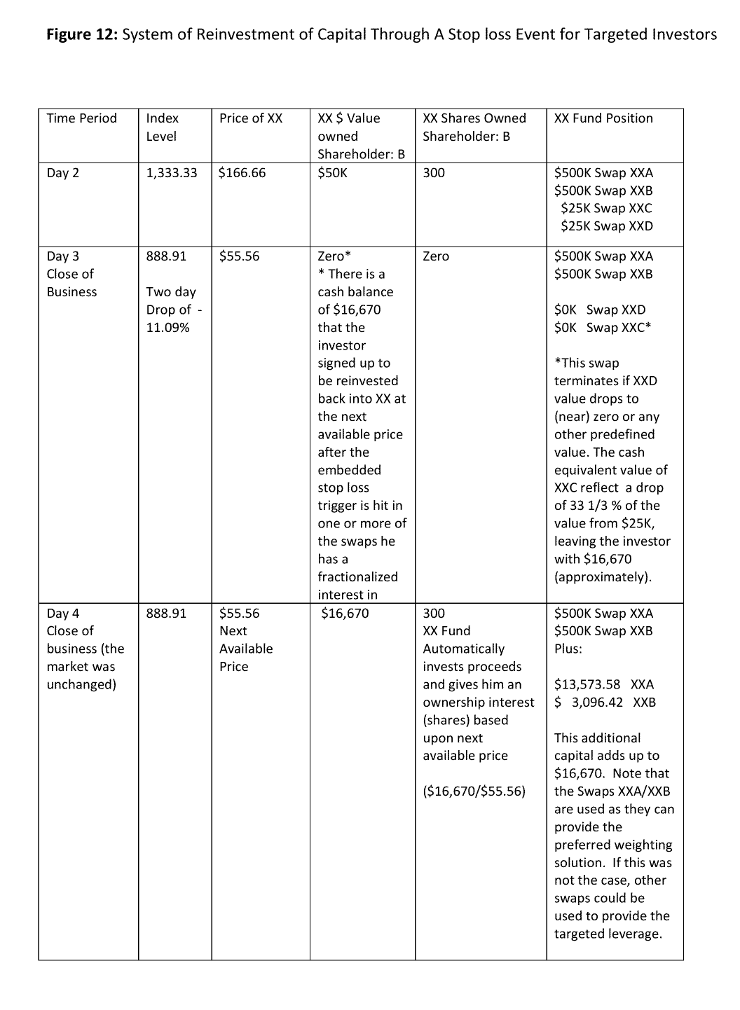

FIG. 12 shows how, on Day 4, the fund takes the proceeds of the stop loss event and purchases securities (Swap XXA/XXB) in the right ratio to provide a two times return of the index for the new capital that comes in. In return, the Fund provides 300 shares to the investor. The example can be applied to both an ETF and once a day mutual fund, or any other target investment security (such as an ETN or Trust). In addition, the shares can be provided on the same day so that the investor would have 300 shares on close of business Day 3.

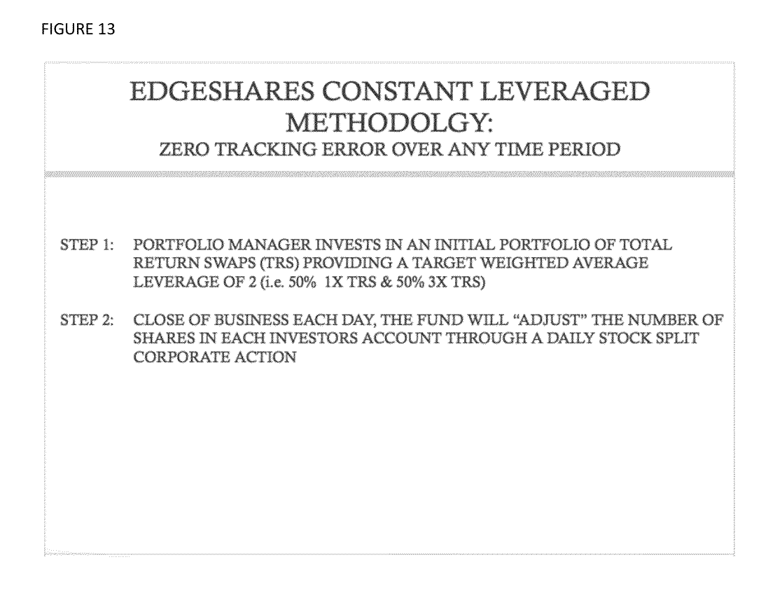

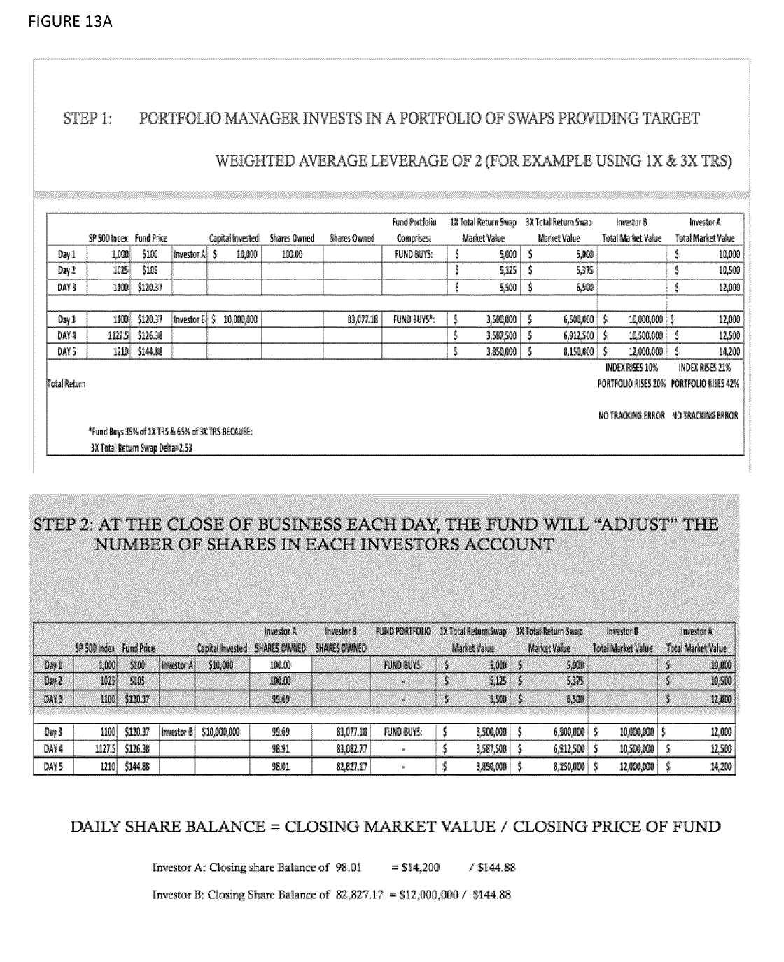

FIG. 13 depicts a two-step summary of an embodiment of the invention that provides zero tracking error over any time period (excluding commissions, fees and other expenses). In Step 1, a portfolio manager invests in an initial portfolio of one or more securities that satisfies a leverage target. The two securities, in combination, provide a weighted average leverage solution of 200%. In Step 2, at the close business each day, the fund will “adjust” the number of shares in each investors account through a daily split or reverse split corporate action.

FIG. 13A provides a detailed example of Steps 1 and 2 as shown within FIG. 13. In Step 1, Investor A owns the embodiment on Day 1 and holds it through Day 5. During that time, the Index rises 21%. His return is 42%. Investor B owns the embodiment on Day 2 and holds it through Day 5. During that time, the Index rises 10%. His return is 20%. Thus, two different investors buying on two different days each receive twice the return of the index over their respective time periods. In Step 2, a detailed depiction of how at the end each business day, the Fund will “adjust” the number of shares in each investor account. Investor A owns 100 shares of the preferred embodiment on Day 1. By the close of business on Day 5, he owns 98.01 shares. Investor B owns 83,077.18 shares on Day 3. By the close of business on Day 5, he owns 82,827.17 shares. The formula used to determine the end of day share balance for each investor is the closing market value of the fund's portfolio of swaps divided by the Funds closing N.A.V. Note that the Fund can determine the N.A.V. more or less frequently than once a day. For example, the value of the fund can be determined hourly or intraday. In addition the fund can accept creation or redemptions more or less frequently than once a day. For example, the fund can allow creations or redemptions hourly or intraday. In addition, the Fund can provide an intraday estimation of the N.A.V. during the day. The shareholder adjustment factor is not shown in this example to illustrate more clearly how the share balance shares over time.

FIG. 14 depicts the different settlement cycles associated with a traditional Mutual Fund, an ETN and an ETF or Trust within the United States. In other countries, these settlement cycles may be shorter or longer. For example, in some countries or trading platforms, ETFs may settle on T+0 or T+1 or longer.

FIG. 14A depicts the fund administration and settlement workflow of a non-exchange traded mutual fund. At 4 pm, a mutual fund processes a request to buy $10,500 of the fund. After the fund determines its Net Asset Value of $105, it issues the investor 100 shares. The next day, after the fund calculates a revised Net Asset Value of $120.37, the fund performs a stock split and reduces the share balance in the investor account to 99.69.

FIG. 14B depicts the administration and settlement workflow of an ETN. After the market closes at 4 pm, an agent of the ETN calculates the economic equivalent of a net asset value. Since ETNs are not funds, it is called the eNAV within the workflow. Once this value is known, the ETN has the outstanding share (unit) balance adjusted for its share (unit) holders. It then sends that data to the clearing corporation (DTCC or CREST, for example). DTCC/CREST then incorporate that information within their nightly corporate action job, which cancels and replaces each trade. The replacement trade will reflect the split or reverse split adjusted quantity and price. As ETNs are debt securities that settle T+1, by 11 am the next day, the transaction has settled delivery versus payment (DVP). Delivery versus payment or DVP is a sale transaction of negotiable securities (in exchange for cash payment) that can be instructed to a settlement agent using SWIFT Message Type MT 543 (in the ISO15022 standard). Use of such standard message types is intended to reduce risk in the settlement of a financial transaction, and enable automatic processing. Ideally, title to an asset and payment are exchanged simultaneously. This can be possible in many cases such as in a central depository system such as the United States Depository Trust Corporation. If a security doesn't settle DVP, which may happen, then one of the counterparties to the trade may be subject to credit risk.

FIG. 14C depicts an example of administration and settlement workflow of an exchange-traded note (ETN). A trade occurs during the day whereby 100 units are purchased at $110 on NYSE ARCA by a buyer, which are matched against 100 units sold by a seller for a total settlement value of $11,000. At the close of business, the ETN calculates its eNAV of $120 and determines that a split is required (0.996926144) and sends this information over to DTCC. DTCC then cancels the matched 100 shares @$110 trade price and replaces it with a matched 99.6926144 shares @$110.339174 trade price. The settlement proceeds of $11,000 remain unchanged for both buyer and seller. The next morning, the investors wake up and review their accounts. The new investor who bought 100 shares at $110 on Tuesday sees that he owns 99.69 (rounded) shares Wednesday morning. The ETN begins trading at $120.37 which provides the investor with a mark value of $12,000, the same closing value he had the night before when the ETN closed at $120 and he owned 100 shares. The seller sees that he longer owns shares of the ETN and now has 100 shares and $11,000 less in his account.

FIG. 14D depicts the proposed settlement and clearing workflow of an ETF, which settles T+3.

The settlement methodology is the same concept as the ETN but the unsettled trades will undergo a stock split (or reverse split) on T+0, T+1 and T+2. The settlement on T+3 will be based upon the final split that occurs on T+2. Thus, the clearing agent will have to cancel and replace each trade multiple times prior to final settlement.

FIG. 14E depicts an alternative settlement and clearing workflow for an ETF. A placeholder ‘dummy’ settlement security is used that references the ticker of the traded security. The benefit of this approach is that the clearing firm can settle the trade without having to cancel and replace it nightly.

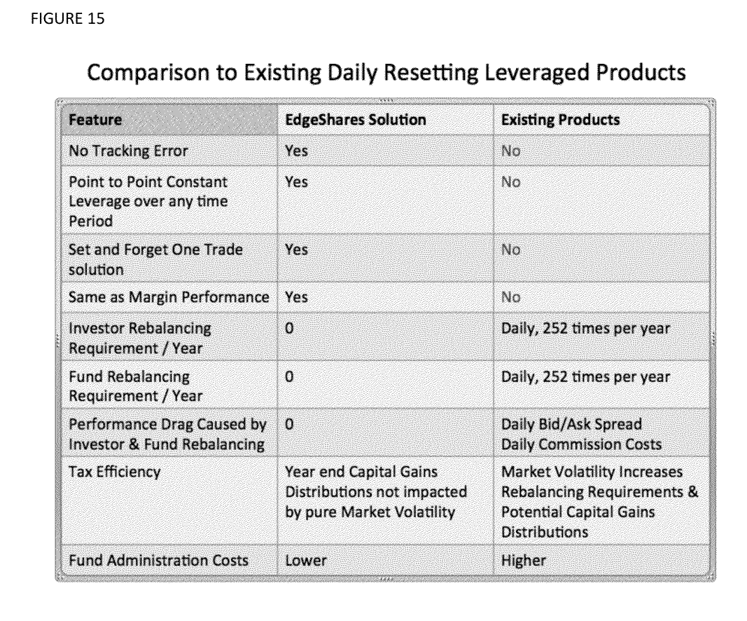

FIG. 15E provides a comparison to existing daily resetting leveraged ETFs. One of the primary advantages of the preferred embodiment over existing leveraged ETFs is that an investor avoids having to rebalance his position 252 a year (i.e. an example of the number of trading days in a year) to maintain constant leverage, which allows an investor to avoid performance drag caused by frequent trading.

FIG. 16 depicts a multi-party global communications and information management technology platform designed, created and maintained to support the determination and dissemination of at least daily stock splits when the products are listed individually or dual listed around the world in multi-time zones comprising at least the fund companies, the clearing entities, the transfer agencies, the brokerage firms, the exchanges and investors. A Company network comprising of computer servers, workstations, a wide area network, a local area network, routers, modems, communications networks, encryption security systems, firewalls, print servers located across one or more geographic or countries and/or time zones generates individually, or in tandem, calculate periodic stock split information files across one or more products and then transmits said information to relevant third parties, including but not limited to Transfer Agents, Clearing & Settlement Corporations, Market Data Providers, Stock Exchanges, Options Exchanges, Fund Supermarkets, Distributors and websites. Storage means within each server are supported by multi-gigabyte hard drives, at least quad core computer processors, gigabytes of ram and/or flash memory and computer displays. Data results can be stored on floppy drives, external drives and exported or disseminated via FTP and/or email either through the Internet or LAN/WAN. Coordination occurs between locations for dually listed products enabling non primary listed exchanges to adjust opening share prices in response to primary listed exchange calculations received by the local office or calculation agent. The Company Network can be owned and operated either by an Adviser, Sub Adviser, Manager, Administrator, Custodian or principal and/or agent of any entity charged with the responsibility of generating stock split information. The method for facilitating a financial transaction by an exchange and/or clearing or settlement agency based upon the received stock split information can comprise a computer at a central or decentralized source operating in part in accordance to a computer program, which can include reference data for an adjusted opening price to be made by an exchange; reference data for updating an executed financial transaction that was made on the exchange and which requires clearing and settlement, the reference data identifying a security and a market where the security is traded along with a stock split factor, the reference data being provided to storage in a first data repository and order for transmission to create or revise a transaction. Each computer program can be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions required. Those skilled in the art understand that additional information can also be generated within FIG. 16 including regulatory filings, tax filings, currency translations, including but not limited to foreign portfolio holding prices back to local prices and vice versa, capital gain or loss information relating to an individual holding or group of holdings, or other required information or documents.

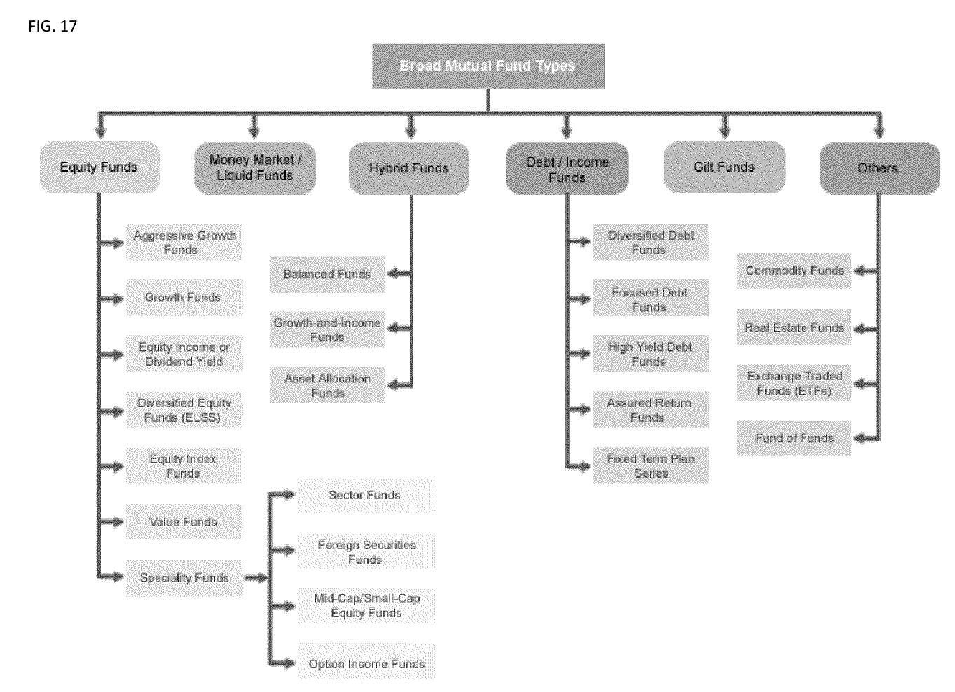

FIG. 17 depicts broad types of mutual funds.

While the embodiments described above provide illustrations and examples of the systems and methods of the invention, the invention should not be considered at all limited to these embodiments and should not limit the scope of the invention, which is defined by the scope of the appended claims. Thus, the Claims should be used to help determine the scope of the invention, with each word cited given its ordinary and plain meaning, without regard to the very specific and detailed features described within the preferred embodiment.

### APPENDIX A

The securities below are not meant to be an exhaustive list of asset classes, security types, security groups, sectors, subsectors or industries, but examples thereof. Many other types, variations or combinations are available. Each of the below securities can either comprise a holding, benchmark, index, reference asset, underlying or derivative of either security XX, XXA and/or XXB as described within this specification.

I. DEBT SECURITIES: 1. Government; 2. United States; 3. Sovereign; 4. Asset Back Securities; 5. Pass-through Securities; 6. REMIC (Real Estate Mortgage Investment Conduit); 7. Bonds: 7(A). Convertible, 7(B). Preferred, 7(C). Revenue, 7(D). Mortgage Backed: 7(D)(i). Agency, 7(D)(ii). Non-Agency, 7(D)(iii) Stripped IO, 7(D)(iv) Stripped PO; 7(E). Deferred Equity; 7(F). Exchangeable; 7(G). Metal Linked/Backed/Collateralized; 7(H). Commodities Linked/Backed/Collateraled; 7(I). Serial; 7(J). Sinking; 7(K). Junk; 7(L). Prime; 7(M). Subprime; 7(N). Tigers, TIPS; 7(O). Paid In Kind (PIK); 7(P). TBAs; 7(Q). Catastrophe; 7(R). Municipal; 8. Notes: 8(A). Exchange Traded, 8(B). Exchangeable, 8(C). Tax Anticipation, 8(D). Litigation Anticipation; 9. Bills; 10. Certificate of Deposit; 11. Collateral; 12. REPO (Open, Term); 13. CMO; 14. CDO; 15. MBS; 16. Litigation Recovery; 17. Equity Linked Eurobond; 18. Certificates; 19. Money Market; 20. Catastrophe; 21. Weather; 22. Corporate; 23. Agency; 24. Any debt instrument.

II. OPTIONS: 1. On Stocks, Commodities, Metals; 2. On Bonds, Notes; 3. On FX; 4. On Futures; 5. On a Leap Adjusted Index or Indices; 6. Deferred Strike; 7. FLEX; 8. LEAPS; 9. Puts; 10. Calls; 11. Expirationless; 12. Exotic (Down and Out, Up and Out, Down and In, Up and In, Barrier); 13. Straddles; 14. Quanto; 15. Volatility Index (VIX); 16. Volatility; and, 17. Any option

III. COMMODITIES: 1. Crude Oil; 2. Gas; 3. Heating Oil; 4. Pork Bellies; 5. Orange Juice; 6. Cocoa; 7. Natural Gas; 8. Coffee; 9. Wheat; 10. Live Cattle; 11. Gasoline; 12. Soybeans; 13. Corn; 14. Cotton; 15. Hogs; 16. Grain; 17. CRB Index and its components; and, 18. Any Commodity Grown Under the Sun.

IV. CONTRACT FOR DIFFERENCE (CFD)

V. CREDIT DERIVATIVES: 1. Credit Default SWAPS (Single Names, Index, Indices); 2. Interest Only SWAPS; 3. Principal Only SWAPS; 4. Index Based; 5. Non-Index Based; 6. Market; and, 7. Any Credit Derivative.

VI. CURRENCY (FOREX): 1. Spot; 2. FX; 3. FX Forward; 4. FX SWAPS; 5. Overnight; 6. Cross Currency; and, 7. Any Currency.

VII. EQUITY: 1. Equity; 2. Preferred Stock; 3. Convertible Stock; 4. Warrants; 5. Debenture; 6. Private; 7. Exchange Traded; 8. Non-Traded; 9. Rights (Offering); 10. Tracking Stock; 11. Depository Shares or Receipts; 12. Certificates; 13. Index Participation Notes; 14. Index Shares; 15. Trust: 15(A). Grantor, 15(B). Unit Investment, 15(C). Business, 15(D). UCITS, UCITS II, UCITS III, UCITS IV; and, 16. Any Equity.

VIII. MUTUAL FUNDS: 1. Exchange Traded (Open Ended or Closed End); 2. Non Exchange Traded; 3. Closed End; 4. Interval Funds; 5. Actively Managed; 6. Passively Managed; 7. Commodity Pool; 8. Depository Receipt; 9. Hub and Spoke; 10. Master/Feeder; and, 11. Any Mutual Fund.

IX. DERIVATIVE: 1. Futures (Short, Long); 2. Options; 3. Swaps; 4. CAPS, Floors, Collars; 5. Any Security Whose Value is Derived from Another Security; and, 6. Any Derivative.

X. INSURANCE PRODUCTS: 1. Annuities (Fixed, Variable); 2. Mortgage Certificates; 3. Investment Contracts; 4. Life; and, 5. Any Insurance Product.

XI. SWAPS: 1. Total Return Swaps; 2. Equity Swaps; 3. Variance Swaps; 4. FX; 5. Commodity; 6. Rollercoaster; 7. Asset; 8. Debt for Equity; 9. Interest Rate; 10. Credit Default; 11. Basis; 12. Swaptions; 13. Ratchet; and, 14. Any swap.

XII. STRUCTURED INVESTMENTS: 1. Rates Linked Notes/CD's; 2. Convertibles; 3. Reverse Convertibles; 4. Linked Notes; 5. Interest Rate; 6. Equity; 7. FX/Commodities/Options; 8. Others, including: 8(A). CMS Floaters, 8(B) Callable Step Coupon Notes, Callable Capped and/or Floored Floaters, 8(C). Stepped Cap/Floor Floater Notes, 8(D). Stepped Spread Callable Floater, 8(E). Inverse Floater Notes, 8(F). Deleveraged & Leveraged Floater Notes, 8(G). Dual-Index Notes (Steepeners), 8(H). Floater with a Curve Cap, 8(I). Flip-Flops (Switch Coupon Bonds), 8(J). Minimum or Maximum of, 8(K). Range Accrual Notes, 8(L). Spread Range Accrual Notes, 8(M). Dual Range Accruals Notes, 8(N). Multi-Range Accrual Notes, 8(O). Countdown Range Accrual Notes, 8(P). Digital Range Notes, 8(Q). Ratchet Floaters, 8(R). Inverse Ratchet Floaters (Snowballs), 8(S). Snowbear Notes, 8(T). Ratchet Range Accruals, 8(U). Inflation Linked Notes, 8(V). Zero Coupon Accreting as a Structured Coupon, 8(W). Target Redemption Notes (TARN), 8(X). Volatility/Absolute Value Notes, 8(Y). Credit Linked Notes, 8(Z). Index Amortization Notes (IAN), 8(AA). Power Reversal Dual Note, 8(AB). Total Return; and, 9. Any Structured Investment.

XIII. HYBRID SECURITY: 1. Those Containing Characteristics of More Than One Security (For Example Equity and Debt); and 2. Any Hybrid Security.

XIV. LOANS: 1. Auto; 2. Credit Card; 3. Line of Credit; 4. Corporate; 5. Revolver; and, 6. Any Loan.

XV. INDEX BASED: 1. Art; 2. Standard and Poors Indices; 3. Russell Indices; 4. Dow Jones Indices; 5. MSCI; 6. Postal Stamps; 7. Wine; 8. Coins; 9. Collectibles; 10. Performance of Hedge Funds; 11. Initial Public Offering; 12. Economic Indicators; 13. Interbank Rate, including LIBOR or Equivalent of another Country; 14. Interest Rate; 15. Default Rate; 16. Spread Between Indexes, including TED Spread; 16. Volatility; 17. Oil Tanker Prices; 18. Patent; 19. Patent Portfolio; 20. Real Estate; 21. Constant Maturity Total Return; and, 22. Any Index.

XVI. INVESTIBLE INDICES

XVII. NON INVESTABLE INDICES

XVIII. INDEX BASED

XIX. METALS: 1. Gold; 2. Silver; 3. Aluminum; 4. Uranium; 5. Rare Earth; 6. Lithium; 7. Copper; 8. Lead; 9. Nickel; 10. Zinc; 11. Steel; 12. Platinum; 13. Palladium; 14. Cobalt; 15. Molybdenum; and, 16. Other Metals or Combinations of Metals included in the Periodic Table.

XXI. ENERGY: 1. Electricity; 2. Nuclear Power; 3. Thorium; 4. Solar; 5. Wind; 6. Ocean Waves; and, 7. Thermal

XXII. INVESTABLE ASSETS

XXIII. NON-INVESTABLE ASSETS

XXIV. YIELD CURVE: 1. Steepner; 2. Flatner; 3. All of the Above—Either OTC or Non-OTC; and, 4. All of the Above—Either with Contango or Without Contango.

### APPENDIX B

Provided below are examples of various embodiments of an exchange traded product that transforms into one or more separate exchange traded products on a user defined redemption basis. Each item should be read either independently or in combination with any other item. Further, the opposite of each item is also reserved as a possible embodiment.

I. Structure: A. Exchange Traded (See Appendix A for examples); B. Non-Exchange Traded (See Appendix A for examples); and, C. Combination of exchange traded and non-exchange traded (for example, security XX is exchange traded and security XXA and/or security) are not exchange traded); D. Master/Feeder; and E. Hub and spoke.

II. Portfolio Management: A. Active (or semi-active); B. Passive (or semi-passive); and, C. Any type of portfolio management.

III. Portfolio Transparency: A. Full; B. Partial; and, C. Timing of display: Delayed, real-time, daily, user defined frequency.

IV. Portfolio Redemption Frequency: A. Daily; B. More frequently than daily (e.g. intra-day, hourly or real-time); and, C. Less frequently than daily (e.g. Multi-daily, weekly, monthly, quarterly, yearly).

Portfolio Distribution Type: A. Mandatory; B. Partial Mandatory; and, C. Strategy based (separately or in combination with a mandatory, non mandatory or partially mandatory distribution methodology).

Weighing of an underlying index or benchmark, portfolio or leverage: A. User defined; B. Equal price weighted; C. Capitalization weighted; D. Geometrically weighted; E. Market value weighted; F. Market share weighted; G. Market capitalization weighted; H. Attribute weighted; I. Custom weighted; J. Revenue weighted; K. Factor weighted; L. Un-weighted; M. Accounting based data weighted (including but not limited to cash flow, book value, debt rating); N. Leverage weighted; and, O. Any type of weighting.

Portfolio Holdings: A. Investable universe of securities, see Appendix A above for additional examples; B. Synthetic securities; C. VIX Index, VIX options; D. CBOES; and, E. Any holding. For avoidance of doubt, a holding can comprise anything available for purchase.

Creation and/or Redemption Basket: A. Two securities; B. More or less than two securities; C. A general ledger accounting treatment.

Leverage: A. Any Inverse performance (e.g. −50, 100%, −200%, −300%); B. Any Multiple (or fraction) of performance (e.g. 50, 150%, 200%, 250%, 300%); C. Leveraged according to predefined formula; D. Non leveraged with a specific distribution based methodology; E. Greater than benchmark or index; F. Less than benchmark or index; G. Non price path dependent; H. No compounding; I. Utilizing a non-exponential formula; and, J. Any type of leverage.

Riskiness: A. Greek risk (e.g., alpha, beta, gamma, delta, theta, lambda, rho); B. Value at risk; C. Sharpe ratio; D. Systemic risk; E. Credit or Default risk; F. Country risk; G. Foreign-Exchange risk; H. Political risk; I. Market risk; J. Interest rate risk; K. Risk/reward ratio; L. Duration; and, M. Any risk measure.

Trading Strategies used in conjunction with an embodiment: A. Portfolio Optimization; B. Convertible Arbitrage; C. Long/short; D. 130/30; E. Relative Value; F. Fundamental Pairs trading; G. Statistical Arbitrage; H. Deep value; I. Global Macro; J. Directional; K. Event-driven; L. Miscellaneous; M. Merger arbitrage; N. Special situation; O. Risk Arbitrage; P. Distressed; Q. Equity Market Neutral; R. Emerging Market; S. Fixed income arbitrage; T. Sector; U. Growth; V. Value; W. Volatility; X. VWAP (volume weighted average price); Y. Technical Analysis; Z. ETF Arbitrage wherein, as an ETF arbitrage mechanism example: if the aggregate price of the ETF's Portfolio Securities is higher than the price of a Creation Unit of such ETF's units/shares, an institutional investor will tender such Creation Unit for redemption and receive the higher-priced underlying Portfolio Securities. Alternatively, if the aggregate price of the ETF's Portfolio Securities is lower than the price of a Creation Unit of such ETF's units/shares, an institutional investor will deposit the basket of Portfolio Securities and receive a Creation Unit.

Class of Shares: A. Single; and, B. Multiple.

Securities Holdings as percentage of a creation unit or creation unit basket (or redemption unit or redemption basket): A. 100%; B. Less than 100%; C. Greater or less than 50%; and, D. Substantially equivalent to a target percentage.

Accounting system: A. Subaccounts; B. Pooled accounts; C. Managed accounts; D. Unmanaged accounts; E. Computerized; F. General Ledger (real-time or batch); and, G. Any type of accounting system by itself.

Asset Management System: Any application system involved in the creation and/or management of an exchange or non exchange traded product.

What is claimed is:

1. A system for administering an exchange traded product, the system comprising:
a. an exchange traded product comprising a number of shares listed for trading on a securities exchange and the shares are bought and sold on the exchange at mutually agreed upon prices;
b. a first processing means configured to receive instructions to adjust the number of shares listed for trading from a daily split or reverse split; and,
c. a second processing means coupled to the first processing means and configured to adjust the number of shares listed for trading on a securities exchange on a daily basis in response to the instructions received by the first processing means and produces an adjusted number of shares.

2. The system of claim 1 wherein the daily instructions provide for at least one of an increase, decrease or no adjustment.

3. The system of claim 1, further comprising a third processing means configured to calculate an estimated intraday value of the product based upon the adjusted number of shares.

4. The system of claim 1 wherein the exchange traded product comprises a stop loss level capable of increasing, decreasing or remaining the same over time.

5. The system of claim 1, further comprising a clearing computer coupled to one of either the first or second processing means and configured to receive instructions to cancel bought or sold transactions and generate a replacement transaction daily until settlement, wherein the replacement transaction incorporates a split or reverse split adjusted quantity and price, provided that if there is an instruction with no adjustment, no replacement transaction will be generated.

6. The system of claim 1 wherein the instructions are received from at least one selected from the group consisting of a sub-adviser, administrator, custodian, transfer agent, exchange, or other designated agent.

7. A method for purchasing or selling exchange-traded shares comprising the steps of:
a. receiving an order to purchase or sell exchange-traded shares associated with an exchange traded product comprising a daily split or reverse split, the product having issued:
i. one or more classes of shares listed for trading on a securities exchange and bought and sold at negotiated market prices, and
ii. a number of the shares outstanding that split or reverse split daily; and
b. executing the order on the exchange to thereby purchase or sell shares.

8. The method of claim 7 wherein the order is received from a broker.

9. The method of claim 7 wherein the order is executed by a market maker.

10. The method of claim 7 wherein the number of shares split or reverse split is zero on one or more days.

11. A system for administering an exchange traded product, the system comprising:
a. an exchange traded product comprising one or more classes of shares listed for trading on a securities exchange and bought and sold on the exchange at mutually agreed upon prices;
b. a first processor configured to provide instructions to calculate on a daily basis a stock split or reverse split factor related to the shares listed for trading in response to a calculation of a daily asset value of the product; and
c. a second processor coupled to the first processor and configured to create an electronic file comprising the calculated split or reverse split factor on a daily basis in response to the instructions provided by the first processor.

12. A method for purchasing or selling exchange-traded options comprising the steps of:
a. receiving an order to purchase or sell exchange-traded options associated with an exchange traded product comprising a number of shares outstanding, the product having issued:
i. one or more classes of shares listed for trading on a securities exchange and bought and sold at negotiated market prices; and
ii. a number of the shares splitting or reverse splitting at least once per week; and
b. executing the order on the exchange to thereby purchase or sell options.

13. The method of claim 12 wherein the exchange traded option is bought and sold during the day by market participants comprising at least one of market makers, brokers and investors on or off the floor of an exchange.

14. A system for administering an exchange traded product, the system comprising:
a. one or more classes of shares listed for trading on a securities exchange wherein the shares are bought and sold on the exchange at negotiated market prices;
b. a first processor configured to provide instructions to calculate a daily split or reverse split on the shares listed for trading in response to a calculated daily net asset value of the product; and
c. a second processor configured to adjust zero or more shares listed for trading on a securities exchange on a daily basis in response to the instructions provided by the first processor; and,
d. a third processor configured to adjust a variable stop loss level when the price of the product reaches a predetermined threshold.

15. A computerized order execution system for an investable product, the system comprising:
a) a first processor configured to process an electronic order to buy or sell ownership interests in a product that splits or reverse splits at least once per week; and,
b) a second processor coupled to the first processor and configured to execute the electronic order processed by the first processor; and,
c) an electronic messaging system coupled to the second processor and configured to send an electronic confirmation of a completed order to buy to sell the product.

16. The system of claim 15 wherein the product is one of a group, the group comprising an exchange traded product, a non exchange traded product.

17. The system of claim 15, further comprising a clearing computer configured to receive instructions to cancel bought or sold transaction on trade date, and generate a replacement transaction daily until settlement, the replacement transaction incorporating a split or reverse split adjusted quantity and price.

18. The system of claim 15 wherein at least one of either the first or second processor is operated by a securities exchange market maker.

19. The system of claim 15, further comprising a third processor configured to calculate at least an estimated intraday value of the product based upon the split or reverse split adjusted number of shares.

20. A method for automatically reinvesting capital received from a stop loss transaction back into the same financial product, the method comprising the steps of:
determining the cash or cash equivalent liquidation proceeds of an investor account relating to the forced liquidation of owning a product as a result of one or more stop loss events;
storing the cash or cash equivalent liquidation proceeds of an investor account relating to the forced liquidation of owning a product as a result of one or more stop loss events;
determining a next available tradable price of the product after a stop loss event has occurred;
storing the next available tradable price of the product after a stop loss event has occurred;
calculating a quantity of ownership that can be purchased of the product, the quantity determinable in part by having a numerator value of A and a denominator value of B;
storing the quantity of ownership that can be purchased of the product;
executing through a pre-authorized investor account an automatic repurchase of the product using the liquidation proceeds; and
executing a reinvestment of proceeds received by a principal or agent of the product.

21. The system of claim 20 wherein the product is selected from a group consisting of exchange traded and non-exchange traded, and wherein outstanding shares are subject to a mandatory split or reverse split on at least one or more of a daily, weekly and or monthly basis.

22. A leveraged product, the product providing one or more investors with fixed, point to point leverage over a defined time period of one day or longer, the product comprising one or more of the following functional attributes:
A. an at least once per week changing share balance for each investor based upon the market value of the shares owned, regardless of whether a buy or sell transaction has been placed; and,
B. a ratched up stop loss level as the product rises to predetermined market index movement levels.

23. The product of claim 22, wherein the product provides for an automated reinvestment of some or all proceeds distributed from a stop loss trigger event.

24. The product of claim 22, wherein the product is exchange traded.

25. The product of claim 22, wherein the product is not exchange traded.

26. The product of claim 22, wherein a derivative is listed for trading.

27. The product of claim 22, wherein the derivative is electronically bought and sold.

28. The product of claim 22, wherein the product is electronically bought and sold.

29. The product of claim 22 wherein the changing share balance occurs at least one of twice a week, three times per week, four times per week, five times per week, more than five times per week.
